(19) United States
(12) Patent Application Publication
(10) Pub. No.: US 2026/0352351 A1
(43) Pub. Date: Nov. 5, 2026

(54) FIRST NODE, FIRST NETWORK NODE, SECOND NODE, COMMUNICATIONS NETWORK AND METHODS PERFORMED THEREBY FOR HANDLING AN INTERFERENCE SIGNAL

(71) Applicant: Telefonaktiebolaget LM Ericsson (publ), Stockholm (SE)

(72) Inventors: Pål FRENGER, Linkoping (SE); Erik G. LARSSON, Linkoping (SE); Zakir Hussain SHAIK, Linkoping (SE)

(21) Appl. No.: 19/122,451

(22) PCT Filed: Oct. 18, 2023
(86) PCT No.: PCT/SE2023/051031

§ 371 Date: Apr. 18, 2025

Related U.S. Application Data
(60) Provisional application No. 63/379,915, filed on Oct. 18, 2022.

(51) Int. Cl. H04B 17/345; H04W 24/08; H04W 24/10

(52) U.S. Cl. CPC H04B 17/345; H04W 24/08; H04W 24/10

(57) ABSTRACT

A method by a first node (121) operating in a communications network (100). The first node (111) is comprised in a set of nodes (120) providing a segmented front-haul. The first node (111) obtains (401) a first indication (formula I) of an interference signal(s) from a second node (122) in the set of nodes (120). The interference signal(s) originates from one or more interfering devices (140) outside the communications network (100). The first node (111) also obtains (402) a second indication (formula II) of the interference signal(s) from uplink measurements and determines (403) a third indication (formula III) of the interference signal (s) as a combination of the first indication and the second indication. The first node (111) then sends (404) the third indication to a third node (123) in the set of nodes (120) or to a first network node (111) having a connection to the set of nodes (120).

### TECHNICAL FIELD

The present disclosure relates generally to a first node, and methods performed thereby, for handling an interference signal. The present disclosure also relates generally to a first network node and methods performed thereby for handling the interference signal. The present disclosure further relates generally to a second node and methods performed thereby for handling the interference signal. The present disclosure further relates generally to a communications network and methods performed thereby for handling the interference signal.

### BACKGROUND

Wireless devices within a wireless communications network may be e.g., User Equipments (UE), stations (STAs), mobile terminals, wireless terminals, terminals, and/or Mobile Stations (MS). Wireless devices may be enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or BTS (Base Transceiver Station), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell may be understood as the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

### NR

The standardization organization 3rd Generation Partnership Project (3GPP) is currently in the process of specifying a New Radio Interface called New Radio (NR) or 5G-Universal Terrestrial Radio Access (UTRA), as well as a Fifth Generation (5G) Packet Core Network, which may be referred to as Next Generation (NG) Core Network, abbreviated as NG-CN, NGC or 5G CN.

In the current concept, gNB denotes an NR BS, where one NR BS may correspond to one or more transmission and/or reception points.

One of the main goals of NR is to provide more capacity for operators to serve ever increasing traffic demands and variety of applications. Because of this, NR may be able to operate on high frequencies, such as frequencies over 6 GHz, until 60 or even 100 GHz.

Operation in higher frequencies makes it possible to use smaller antenna elements, which enables antenna arrays with many antenna elements. Such antenna arrays facilitate beamforming, where multiple antenna elements may be used to form narrow beams and thereby compensate for the challenging propagation properties.

### Internet of Things (IoT)

The Internet of Things (IoT) may be understood as an internetworking of communication devices, e.g., physical devices, vehicles, which may also be referred to as “connected devices” and “smart devices”, buildings and other items-embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g. a “smart” thermostat, ventilation, air conditioning, and appliances such as washer, dryers, ovens, refrigerators or freezers that may use telecommunications for remote monitoring.

These devices may collect data with the help of various existing technologies and then autonomously flow the data between other devices.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that may be understood to be a self and/or automatically controlled unattended machine and that may be understood to be typically not associated with an active human user in order to generate data traffic. An MTC device may be typically simpler, and typically associated with a more specific application or purpose, than, and in contrast to, a conventional mobile phone or smart phone. MTC may be understood to involve communication in a wireless communication network to and/or from MTC devices, which communication typically may be of quite different nature and with other requirements than communication associated with e.g. conventional mobile phones and smart phones. In the context of and growth of the IoT, it is evident that MTC traffic will be increasing and thus needs to be increasingly supported in wireless communication systems.

### D-MIMO

Distributed Multiple-Input and Multiple-Output (D-MIMO), also known as “cell-free massive MIMO”, Radio Stripes, RadioWeaves, etc. may be understood as a technology candidate for the Sixth Generation (6G) physical layer. Cell-free may be understood to mean that, in contrast to using one of several access points (APs) to form a cell with a fixed configuration, the cell-free concept may be understood to allow grouping multiple APs in a flexible manner based on where the UEs may be located. While there may be no prior fixed “cell” definition for data transmission, for control and broadcast information distribution, there may still be more traditional cells.

The basic idea of D-MIMO may be understood to be to distribute service antennas geographically and have them operate phase-coherently together. A typical architecture may be that multiple antenna panels, also known as access points (APs) or communication service points (CSPs), may be interconnected and configured in such a way that more than one panel may cooperate in coherent decoding of data from a given UE, and more than one panel may cooperate in coherent transmission of data to a UE. Each panel in turn may comprise multiple antenna elements that may be configured to operate phase-coherently together. The preferred way of operation may be in time-division duplex (TDD), relying on reciprocity of the propagation channel, whereby uplink pilots transmitted by the UEs may be used to obtain both the uplink and downlink channel responses simultaneously. This type of TDD operation may be usually called reciprocity-based operation. Various research projects, for example H2020-REINDEER, are addressing aspects relating to this architecture, including the design of beamforming methods, random access signaling and procedures, etcetera.

### Modular D-MIMO: Radio Stripes and RadioWeaves

To make deployment of a large number of D-MIMO access points simple and cost efficient, various approaches have been proposed, such as Radio Stripes and RadioWeaves. A common feature may be understood to be to use a shared fronthaul (FH) together with a high degree of integration and miniaturization, see FIG. 1 and FIG. 2. Sometimes, the electronic circuit containing the digital signal processor (DSP), antenna panel, and external interfaces, for power supply and data, may be denoted by antenna processing unit (APU). In this document, it may be referred to as Access Point (AP). Note however that APs may not be visible physical boxes, they may in some cases be only the location of a small integrated circuit, that is, a Radio Frequency System-on Chip (RF SoC) placed e.g., inside of a protective cable.

FIG. 1 depicts a schematic example illustration of an antenna processing unit 1 top view in panel a) and side view in panel b), respectively. The antenna processing unit 1 may comprise one or more antenna elements 2, which may be located in an antenna panel 3, and an external interface 4 on a printed circuit board (PCB) 5. In panel b), the external interface 4 is depicted as a separate component. The DSP 6 is depicted under the antenna panel 3.

FIG. 2 is a schematic diagram representing two different network deployment and architecture examples. Panel a) depicts a non-limiting example of the RadioWeaves planar approach to interconnect APs. Panel b) depicts a non-limiting example of the RadioStripes linear approach to interconnect APs. It may be appreciated that a Central Processing Unit (CPU) 21 may be connected, via one or more connections, to a plurality of APs 22. A CPU may be understood as a node, e.g., Distributed Unit (DU), with coordinating capabilities for connection control among APs in a centralized manner. In case of ad-hoc structure, a CPU may not have any controller role. Each of the APs 22 may be connected to another AP 22 via one or more FH segments 23. The plurality of APs 22 may be arranged in a dispersed, planar, form in the radioweave, or in a linear form in the radio stripe.

### Segmented Fronthaul

The fronthaul structure used by e.g., RadioStripes and RadioWeaves may be referred to as segmented fronthaul. Each AP may be connected to one or more neighboring APs via interfacing segments that may be used for transferring power, DL data packets and precoding weights, UL combining weights and data symbol estimates, etc. The existence of the plurality of segments between the APs may be understood to then result in a segmented fronthaul. An important property of such FH structure may be understood to be that a given AP may be generally not directly connected to the CPU but to signal to and from it may need to pass multiple segments to reach their destinations. To transfer signals to and from multiple UEs and multiple APs, careful routing solutions may be required to utilize the data transfer capabilities of the segments as fully as possible. The segment capacities in terms of data packets per time unit may be estimated e.g., in Gigabits per second (Gbps) or in UE packets/radio slot. Herein, routing may be understood to denote the necessary data, user-plane and/or control-plane data, forwarding throughout fronthaul network, and not addressing any Internet Protocol (IP)-level routing.

Uplink processing methods for D-MIMO may rely on joint coherent processing of signals sent by multiple UEs. This may in turn require channel estimates which may be obtained either from uplink pilots sent by the UEs, e.g., in TDD mode, or by feedback of channel estimates from the UEs, e.g., in Frequency Division Duplex (FDD). Given these estimates, many methods may be available for separation of the streams transmitted by the UEs, for example, maximum-ratio (MR) processing, zero-forcing (ZF) processing, and Minimum mean square error (MMSE) processing. Distributed implementations of these methods, with low fronthaul costs, may also be available [1,2].

### Out-of-System (OoS) Interference

If the system operates in unlicensed spectrum or if the system is sharing spectrum with another (primary) system, there may be out-of-system (OoS) interference that cannot be estimated through reliance on uplink pilots, or Channel state information (CSI) feedback, for that matter. Such OoS interference may have the properties that: i) the interference signal may be understood to be the same, but unknown, at all APs, and ii) the corresponding channels at different APs may be understood to be different, and unknown. The main way in which OoS interference may be understood to differ from “regular” in-system interference from other UEs may be understood to be that for regular interference, the associated pilot signal may be understood to be known, which may facilitate channel estimation in a straightforward manner.

State-of-the-art methods for suppression of OoS interference may use either of the following two options:
a) Process all signals centrally and apply interference rejection combining. The basic methodology may be understood to go back at least to [3]: model the OoS interference as a spatially correlated signal, whose spatial correlation may be estimated from the uplink pilot signal collectively obtained by all APs. Specifically, after estimating the channels to the desired UEs, a residual may be formed by subtracting the estimated channels multiplied by the corresponding pilot sequences from the received pilot signal; details are provided later in this document. From this residual, the spatial characteristics of the OoS interference may be determined. With L APs having M antennas each, an LM×LM covariance matrix of the residual may be determined.
b) Process the signals in a decentralized manner at each AP. This may entail, per AP, modeling the OoS interference as a spatially correlated signal, and then applying a standard interference rejection combining method. However, with such distributed processing, no coherent gain, for the interference suppression, may be obtained from processing across multiple APs. At each AP, having, e.g., M antennas, an M×M covariance matrix of the residual signal may be understood to have to be estimated; each such covariance matrix may describe the OoS interference signal correlation among antennas within each AP, but not across different APs.

According to existing methods of suppression of OoS interference may result in large upfront load and/or loss of performance, which may in turn result in poor user experience.

### SUMMARY

As part of the development of embodiments herein, one or more challenges with the existing technology will first be identified and discussed.

The existing, above-described solutions a) to process all signals centrally and b) to process the signals in a decentralized manner at each AP are undesirable for the following two respective reasons.

Regarding the first approach, central processing of all signals entails a huge fronthaul load. Centralized interference rejection combining methods for OoS interference known in the art cannot benefit from recently invented sequential processing schemes for D-MIMO, such as the Kalman filter [1,2].

Regarding the second approach, methods for per-AP decentralized OoS interference suppression cannot exploit the fact that the received OoS interference signal may be understood to be the same at all APs, albeit the channels may be understood, again, to be different. This results in a significant loss of performance with respect to centralized processing.

According to the foregoing, it is an object of embodiments herein to improve the handling of an interference signal in a communications network.

According to a first aspect of embodiments herein, the object is achieved by method, performed by a first node. The method is for handling an interference signal. The first node operates in the communications network. The first node is comprised in a set of nodes providing a segmented front-haul. The first node obtains at least a first indication. The first indication is of an interference signal from a second node operating in the communications network and comprised in the set of nodes. The interference signal originates from one or more interfering devices outside of the communications network. The first node also obtains a second indication of the interference signal. The obtaining of the second indication is from uplink measurements performed by the first node. The first node then determines a third indication of the interference signal as a combination of the obtained first indication and the obtained second indication. The first node then sends the third indication to a third node operating in the communications network and comprised in the set of nodes, or to a first network node operating in the communications network and having a connection to the set of nodes.

According to a second aspect of embodiments herein, the object is achieved by a method, performed by the first network node. The method is for handling the interference signal. The first network node operates in the communications network comprising the set of nodes providing the segmented front-haul. The first network node obtains the third indication from the first node comprised in the set of nodes. The third indication is of the interference signal. The interference signal originates from the one or more interfering devices outside of the communications network. The third indication is of the interference signal as the combination of at least the first indication of the interference signal from the second node operating in the communications network and comprised in the set of nodes, and the second indication of the interference signal, as obtained by the first node from the uplink measurements performed by the first node. The first network node then determines a fourth indication. The fourth indication is of the interference signal. The fourth indication is based on an estimation of the interference signal by the first network node based on at least the third indication obtained from the first node. The first network node then sends, directly or indirectly, the fourth indication to the first node.

According to a third aspect of embodiments herein, the object is achieved by a method, performed by the second node. The method is for handling the interference signal. The second node operates in the communications network. The second node is comprised in the set of nodes providing the segmented front-haul. The second node obtains the first indication of the interference signal. The obtaining of the interference signal is from uplink measurements performed by the second node. The interference signal originates from the one or more interfering devices outside of the communications network. The second node then sends the first indication to the first node operating in the communications network and comprised in the set of nodes.

According to a fourth aspect of embodiments herein, the object is achieved by the first node, for handling the interference signal. The first node is configured to operate in the communications network. The first node is configured to be comprised in the set of nodes configured to provide the segmented front-haul. The first node is configured to obtain at least the first indication of the interference signal from the second node configured to operate in the communications network and configured to be comprised in the set of nodes. The interference signal is configured to originate from the one or more interfering devices outside of the communications network. The first node is also configured to obtain the second indication of the interference signal from the uplink measurements configured to be performed by the first node. The first node is configured to determine the third indication of the interference signal as the combination of the obtained first indication and the obtained second indication. The first node is also configured to send the third indication, to the third node configured to operate in the communications network and configured to be comprised in the set of nodes, or to the first network node configured to operate in the communications network and configured to have the connection to the set of nodes.

According to a fifth aspect of embodiments herein, the object is achieved by the first network node, for handling the interference signal. The first network node is configured to operate in the communications network. The communications network is configured to comprise the set of nodes configured to provide the segmented front-haul. The first network node is further configured to obtain the third indication from the first node configured to be comprised in the set of nodes. The third indication is configured to be of the interference signal. The interference signal is configured to originate from the one or more interfering devices outside of the communications network. The third indication is configured to be of the interference signal as a combination of at least the first indication of the interference signal from the second node configured to operate in the communications network and configured to be comprised in the set of nodes, and the second indication of the interference signal as configured to be obtained by the first node from uplink measurements configured to be performed by the first node. The first network node is then configured determine the fourth indication of the interference signal. The fourth indication configured to be based on the estimation of the interference signal by the first network node configured to be based on at least the third indication configured to be obtained from the first node. The first network node is also configured to send, directly or indirectly, the fourth indication to the first node.

According to a sixth aspect of embodiments herein, the object is achieved by the second node, for handling the interference signal. The second node is configured to operate in the communications network. The second node is configured to be comprised in the set of nodes configured to provide the segmented front-haul. The second node is configured to obtain the first indication of the interference signal from uplink measurements configured to be performed by the second node. The interference signal is configured to originate from the one or more interfering devices outside of the communications network. The second node is also configured to send the first indication to the first node configured to operate in the communications network and configured to be comprised in the set of nodes.

According to a seventh aspect of embodiments herein, the object is achieved by the communications network comprising the first node, the first network node, and the second node.

Embodiments herein, may be understood to enable suppression of OoS interference in the communications network, e.g., a D-MIMO, through distributed signal processing, at a much lower fronthaul cost than existing solutions, and at a marginal performance loss compared to fully centralized processing.

The reduced fronthaul requirement may have direct impact on cost and energy efficiency of the system.

### BRIEF DESCRIPTION OF THE DRAWINGS

Examples of embodiments herein are described in more detail with reference to the accompanying drawings, according to the following description.

FIG. 1 depicts a schematic example illustration of an antenna processing unit, top view in panel a) and side view in panel b).

FIG. 2 is a schematic diagram representing two different network deployment and architecture examples, RadioWeaves in panel a) and RadioStripes in panel b).

FIG. 3 is a schematic diagram illustrating a communications network, according to embodiments herein.

FIG. 4 is a flowchart depicting a method in a first node, according to embodiments herein.

FIG. 5 is a flowchart depicting a method in a first network node, according to embodiments herein.

FIG. 6 is a flowchart depicting a method in a second node, according to embodiments herein.

FIG. 7 is a schematic diagram illustrating an example of embodiments herein, where the estimation of s may be achieved by forwarding all residuals to the CPU.

FIG. 8 is a schematic diagram illustrating an example of embodiments herein, where the estimation of s may be achieved by sequential accumulation of Gramians.

FIG. 9 is a schematic diagram depicting a preferred embodiment where the estimation of s may be achieved by sequential averaging and phase rotation.

FIG. 10 is a graphical representation depicting experimental results indicating the benefits of embodiments herein.

FIG. 11 is a schematic block diagram illustrating a first node, according to embodiments herein.

FIG. 12 is a schematic block diagram illustrating a first network node, according to embodiments herein.

FIG. 13 is a schematic block diagram illustrating a second node, according to embodiments herein.

FIG. 14 is a schematic block diagram illustrating an example of a communication system 1400 in accordance with some embodiments.

FIG. 15 is a schematic block diagram illustrating a host 1500, which may be an embodiment of the host 1416 of FIG. 14, in accordance with various aspects described herein.

FIG. 16 shows a communication diagram of a host 1602 communicating via a network node 1604 with a UE 1606 over a partially wireless connection in accordance with some embodiments.

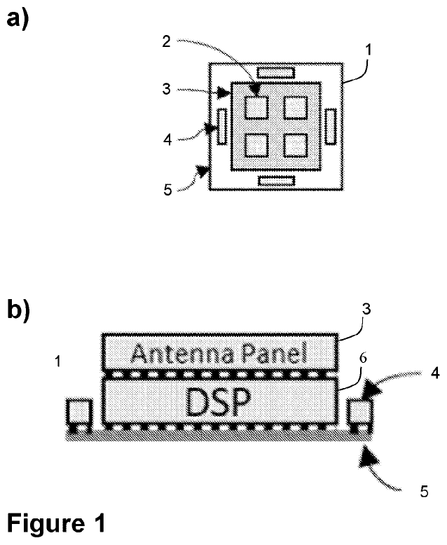

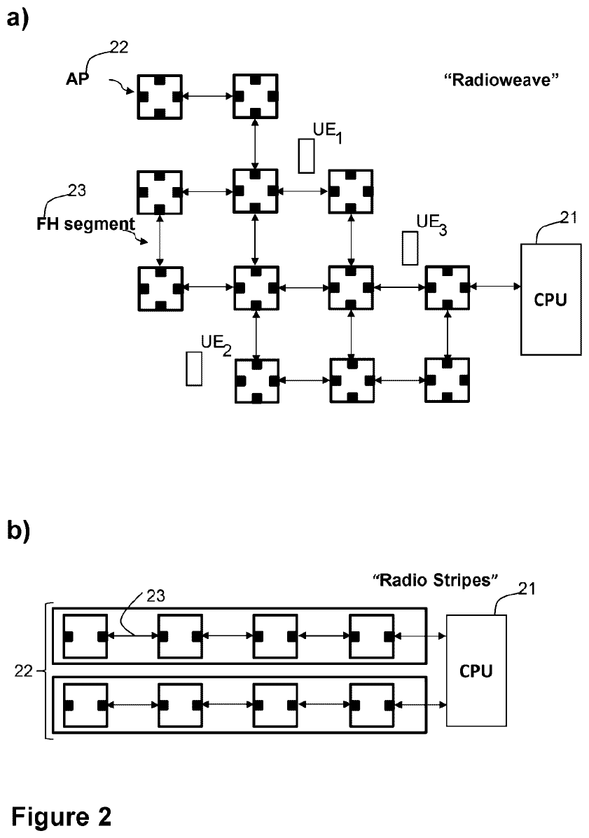

### DETAILED DESCRIPTION

Certain aspects of the present disclosure and their embodiments may provide solutions to these or other challenges. Embodiments herein may be generally understood to relate to efficient out-of-system interference suppression in uplink D-MIMO. Particularly, embodiments herein may be understood to relate to a decentralized method for suppression of uplink OoS interference, that may operate with a low fronthaul cost. Embodiments herein may be understood to enable a low-fronthaul-cost method for distributed suppression of uplink OoS interference in D-MIMO. The method may operate as follows.

During the pilot phase:
i. Based on uplink pilots, each AP may estimate the uplink channels of the desired signals, corresponding to the UEs that may be being served by the system.
ii. Based on the received pilots, each AP may further obtain a residual signal that may contain “unexplained” parts of the received pilots. This residual may specifically contain interference on the pilot channel from the OoS interference, plus noise and estimation errors.
iii. Each AP may apply a data compression algorithm to its residual signal. In a preferred example, this data compression may consist of a singular value decomposition in which only the leading singular vector component may be kept.
iv. In a preferred example, the APs may be connected in a stripe topology, and AP l−1 may then forward its compressed residual to AP l. In an alternative example, each AP may forward the compressed residual to the CPU.
v. In a preferred example, AP l may obtain its compressed residual and combine it with the accumulated compressed residual obtained from at least one other AP, e.g., AP l−1. In the preferred example, said combination may be based on a phase-rotation plus averaging, see the Section entitled “Estimation of s by sequential averaging and phase rotation (preferred example)”.
vi. In a preferred example, the CPU may receive the final accumulated compressed residual, obtained through sequential processing of all residuals from all APs serving said UEs.
vii. Based on the final accumulated compressed residual, the CPU may form a final estimate of the OoS interference signal. This estimated interference signal may be transmitted back to all APs.
viii. Each AP may now have an accurate, that is, much more accurate than what may be possible from local processing alone, estimate of the OoS interference signal. This estimate may be used at each respective AP to estimate the corresponding channel to the OoS interferer.

Once an accurate estimate of the channel to the OoS interferer may have been obtained at each AP, through the above-described procedure, any standard method for interference suppression may be applied. In the preferred example, the OoS interference symbol or sample may be treated as just another data symbol. This may enable the use of sequential processing methods known in the art, for example, [1,2].

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from LTE/5G has been used in this disclosure to exemplify the embodiments herein, this should not be seen as limiting the scope of the embodiments herein to only the aforementioned system. Other wireless systems with similar features, may also benefit from exploiting the ideas covered within this disclosure.

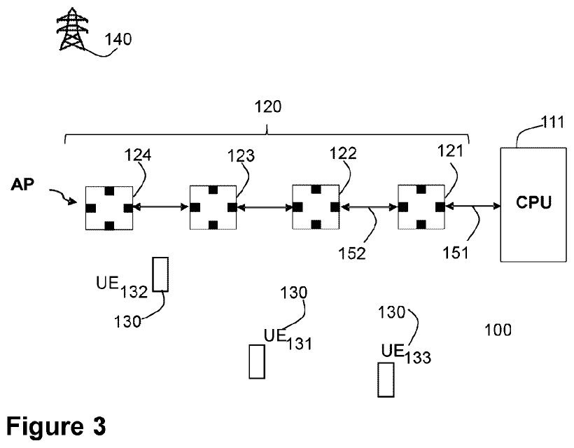

FIG. 3 depicts a non-limiting example of a communications network 100, in some examples also referred to as a wireless communications system, cellular radio system, or cellular network, in which embodiments herein may be implemented. The communications network 100 may typically be a 5G system, 5G network, NR-U or Next Gen System or network, Licensed-Assisted Access (LAA), or MulteFire. In particular embodiments, the communications network 100 may be a D-MIMO network, e.g., a D-MIMO network with segmented fronthaul. The communications network 100 may support or be a younger system than a 5G system, such as, for example a 6G system. The communications network 100 may support other technologies, such as, for example Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, etc. Other examples of other technologies the communications network 100 may support may be Wideband Code Division Multiple Access (WCDMA), Universal Terrestrial Radio Access (UTRA) TDD, Global System for Mobile Communications (GSM) network, Enhanced Data Rates for GSM Evolution (EDGE) network, GSM EDGE Radio Access Network (GERAN) network, Ultra-Mobile Broadband (UMB), network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), IoT, Narrowband Internet of Things (NB-IoT), or any cellular network or system. Thus, although terminology from 5G/NR and LTE may be used in this disclosure to exemplify embodiments herein, this should not be seen as limiting the scope of the embodiments herein to only the aforementioned systems.

It may be understood that the layout of the communications network 100 depicted in FIG. 3 is a non-limiting example.

As depicted in FIG. 3, the communications network 100 comprises a first network node 111. The first network node 111 may be understood as a first computer system. In some examples, the first network node 111 may be implemented as a standalone server in e.g., a host computer in the cloud. The first network node 111 may in some examples be a distributed node or distributed server, with some of its functions being implemented locally, e.g., by a client manager, and some of its functions implemented in the cloud, by e.g., a server manager. Yet in other examples, the first network node 111 may also be implemented as processing resources in a server farm.

The first network node 111 may be a Central Processing Unit (CPU) in the communications network 100, or a node connected to the CPU in the communications network 100. In particular embodiments, the first network node 111 may be a CPU of the d-MIMO network.

In some non-limiting examples, the first network node 111 may be a radio network node. As a radio network node, the first network node 111 may be a transmission point such as a radio base station, for example a gNB, an eNB, or any other network node with similar features capable of serving a wireless device, such as a user equipment or a machine type communication device, in the communications network 100. In typical examples, the first network node 111 may be a base station, such as a gNB. In other examples, the first network node 111 may be a distributed node, such as a virtual node in the cloud, and may perform its functions entirely on the cloud, or partially, in collaboration with a radio network node.

The first network node 111 may be understood as a network node having a capability to obtain and analyze radio information pertaining to the communications network 100.

The communications network 100 may cover a geographical area, which in some embodiments may be divided into coverage areas, wherein each coverage area may be served by a radio network node, although, one radio network node may serve one or several coverage areas. As a radio network node, 111 may be of different classes, such as, e.g., macro eNodeB, home eNodeB or pico base station, based on transmission power and thereby also coverage area size. In some examples, as a radio network node, the first network node 111 may serve receiving nodes with serving beams. The first network node 111, e.g., as radio network node, may support one or several communication technologies, and its name may depend on the technology and terminology used. The first network node 111 may be directly connected to one or more core networks.

The communications network 100 also comprises a set of nodes 120. The set of nodes 120 may provide a segmented front-haul. The set of nodes 120 may comprise a first node 121 and a second node 122. In some embodiments, the set of nodes 120 may comprise a third node 123. In the non-limiting example depicted in FIG. 3, the set of nodes 120 further comprises the third node 123 and a fourth node 124, but this may be understood to be for illustration purposes only. The set of nodes 120 may comprise fewer or additional nodes. Any of the nodes in the set of nodes 120 may be understood to be an Access Point (AP). An AP may be understood as a hardware unit with transmission/reception capability comprising at least an antenna panel and radio circuitry, and a fronthaul connection via at least one segment. An AP may be also referred as an APU or TRP. Any reference herein to a “node” may be understood to refer to a node in the set of nodes 120, e.g., an AP. In typical embodiments, each of the nodes in the set of nodes 120 may be an AP. Each of the nodes in the set of nodes 120 may have a respective plurality of antennas M. The set of nodes 120 may be interconnected and configured in such a way that more than one panel may cooperate in coherent decoding of data from a given device, of one or more devices 130 comprised in the communications network and described below, and more than one panel may cooperate in coherent transmission of data to a device, of the one or more devices 130 comprised in the communications network 100. The set of nodes 120 may have a layout or arrangement. The first node 121 and the second node 122 may be immediately adjacent in the arrangement of the set of nodes 120. The first node 121 may be closer to the first network node 111 than the second node 122. In the non-limiting example of FIG. 3, the set of nodes 120 are arranged with a stripe topology. Particularly, in some embodiments, such as in the non-limiting example of FIG. 3, the set of nodes 120 may be arranged with a stripe topology, wherein the first node 121 and the second node 122 may be immediately adjacent. Other topologies than that depicted in FIG. 3 are possible. For example, the set of nodes 120 may have a radioweave topology, e.g., wherein the first node 121 and the second node 122 may be immediately adjacent.

Any of the one or more devices 130 comprised in the communications network 100 may be a wireless device or wireless communication device such as a 5G UE, or a UE, which may also be known as e.g., mobile terminal, wireless terminal and/or mobile station, a Customer Premises Equipment (CPE), a mobile telephone, cellular telephone, or laptop, e.g., with wireless capability, just to mention some further examples. Any of the one or more devices 130 comprised in the communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, IoT device, sensor, or any other radio network unit capable of communicating over a radio link in a communications system. Any of the one or more devices 130 comprised in the communications network 100 may be enabled to communicate wirelessly in the communications network 100. The communication may be performed e.g., via a RAN, and possibly the one or more core networks, which may be comprised within the communications network 100. The one or more devices 130 comprised in the communications network 100, are represented, in the non-limiting example of FIG. 3, as three devices: a first device UE₁₃₁, a second device UE₁₃₂, and a third device UE₁₃₃. It may be understood that this is for illustration purposes only, and that more or less devices 130 may be comprised in the communications network 100.

One or more interfering devices 140 may cause interference in the communications network 100. The one or more interfering devices 140 may be outside of the communications network 100. That is, the interference caused by the one or more interfering devices 140 may be understood to be OoS interference, from a source outside of the network. The one or more interfering devices 140 may be, e.g., other UEs in the same, unlicensed or shared, band than that wherein the communications network 100 operates. In other examples, the one or more devices 140 may be, e.g., non-communication transmitters that may leak electromagnetic interference, such as welding equipment or microwave ovens, or from intentional jammers or spoofers, a single-antenna transmitter, a multi-antenna transmitter, or both. For example, the one or more interfering devices 140 may comprise one or more radio network nodes, as described above.

The first network node 111 may be configured to communicate within the communications network 100 with the first node 121 over a first link 151, e.g., a radio link, for example a first beam, or a wired link. The first node 121 may be configured to communicate within the communications network 100 with the second node 122 over a second link 152, e.g., a radio link, for example a first beam, or a wired link. Any of the nodes in the set of nodes 120 may be configured to communicate within the communications network 100 with nodes in the set of nodes 120 or with the first network node 111 over a respective link, e.g., a radio link or a wired link, which may be understood to be a respective FH segment. Any of the nodes in the set of nodes 120 may be configured to communicate within the communications network 100 with the one or more devices 130 over another respective link, e.g., a radio link. The respective links and the another respective links are not depicted in FIG. 3 to simplify the figure.

In general, the usage of “first”, “second”, “third” and/or “fourth” herein may be understood to be an arbitrary way to denote different elements or entities, and may be understood to not confer a cumulative or chronological character to the nouns they modify.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a first node, such as the first node 121, e.g., a first AP, embodiments related to a first network node, such as the first network node 111, e.g., a CPU, and embodiments related to a second node, such as the second node 122, a second AP.

Some embodiments herein will now be further described with further detailed disclosure and some non-limiting examples.

In the following description, any reference to a/the UE, or simply “UE” may be understood to equally refer to any of the one or more devices 130; any reference to the UEs, or simply “UEs” may be understood to equally refer to the one or more devices 130; any reference to a/the AP l, and/or “the last AP” may be understood to equally refer to the first node 121; any reference to a/the AP l−1, may be understood to equally refer to the second node 122; any reference to the APs or simply “APs”, may be understood to equally refer to the set of nodes 120; Similarly, any reference to each AP/all APs may be understood to refer to each AP/all APs of the set of nodes 120; any reference to a/the CPU may be understood to equally refer to the first network node 111; any reference to a/the OoS interferer may be understood to equally refer to the one or more interfering devices 140.

In this document, the following system model of the communications network 100 may be used to illustrate embodiments herein.

### System Model

In this disclosure, the communications network 100 may be considered as a D-MIMO system with L APs, each equipped with M antennas. The L APs may be understood as examples of the set of nodes 120. For simplicity, it may be further considered that the system may be serving K single-antenna UEs. The UEs may be understood as examples of the one or more devices 130. It may be noted, however, that the methods described herein are not limited to single-antenna UEs, and a person skilled in the art may be able to extend the analysis to the case of multi-antenna UEs. In may be considered henceforth the standard block fading abstraction of the channel, under which all channels may be understood to be static during a coherence interval, that is, resource block, and herein, it may be considered, exclusively, the uplink. All channels between APs and UEs may be understood to be a priori unknown and estimated from uplink pilots.

In the uplink signal received at the APs, there may be unknown out-of-system (OoS) interference present that may originate from a source outside of the network. For example, the one or more interfering devices 140. More specifically, in the main use case, the system may operate in unlicensed spectrum or in a spectrum shared with another system, and the interference may then originate from other UEs in the same, unlicensed or shared, band. Yet, the methods disclosed herein may be understood to be equally applicable if the OoS interference originates from non-communication transmitters that may leak electromagnetic interference, such as welding equipment or microwave ovens, or from intentional jammers or spoofers. The OoS interference that may be understood to be in focus here may not be confused with multiuser interference within the system: for example, when decoding a signal from the k:th UE, UEs 1, . . . , k−1, k+1, . . . , K may interfere; that multiuser interference, however, may be readily dealt with using known methods.

As for the OoS interference, it may be assumed herein in the modelling work that it may originate from a single-antenna transmitter. In case the OoS stems from multiple sources, or a multi-antenna transmitter, or both, one may view the method disclosed herein as a first-order approximation that may cancel the dominant direction of the interference signal, or rather, the dominant component of the singular space associated with the OoS interference.

Embodiments herein may denote by Hₗ=[hₗ . . . h_{Kl}] the channel matrix, dimension: M×K, between the K UEs and AP l, with hₖₗ being the channel between UE k and AP l. Also, denote by gₗ the channel between the OoS interferer and AP l. A mathematical model for the received signal at AP l, at any point in time, may be understood to be

yₗ=\sqrt{p}Hₗx+gₗs+nₗ
where x may be understood to comprise the symbols collectively sent by the K UEs and s may be understood to be the OoS signal; nₗ is noise, and p may be understood to be the transmit power, normalized.

In the text herein, the usage of formulas and mathematical terms next to nouns, as reflected in parenthesis in the claims, may be understood to be used as an expression of reference numerals. These reference numerals may be used as illustrative examples and therefore not limiting. For example, the expression “a first indication

$${Z}_{l - 1} , {\sum }_{i = 1}^{l - 1} {Z}_{i}^{H} {Z}_{i} , {\text{?}}_{( l - 1 )} ”$$

may be understood to mean that the first indication may be, in some non-limiting examples “Zₗ₋₁”, while in other non-limiting examples it may be

$$“ {\sum }_{i = 1}^{l - 1} {Z}_{i}^{H} {Z}_{i} ”$$

and yet it other examples it may be “ [symbol] ₍ₗ₋₁₎”.

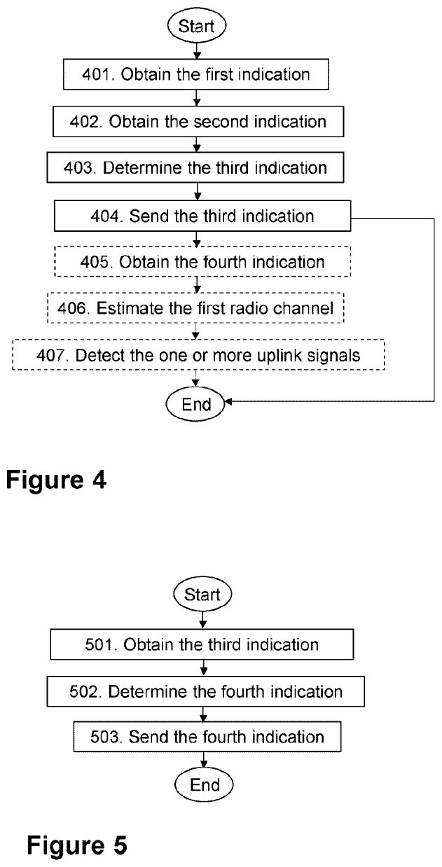

Embodiments of a method performed by a first node, such as the first node 121, will now be described with reference to the flowchart depicted in FIG. 4. The method may be understood to be for handling an interference signal, which may be referred to herein as s. The first node 121 operates in in a communications network, such as the communications network 100. The first node 121 is comprised in the set of nodes 120 providing a segmented front-haul.

The method may be understood to be a computer-implemented method performed by the first node 121.

In some embodiments, at least one of the following may apply: a) each of the nodes in the set of nodes 120 may be an AP, b) each of the nodes in the set of nodes 120 may have the respective plurality of antennas M, c) the communications network 100 may be a d-MIMO network, d) the first network node 111 may be a CPU of the d-MIMO network, e) the set of nodes 120 may be arranged with a stripe topology, and f) the set of nodes 120 may be arranged with a radioweave topology, and g) the set of nodes 120 may be arranged with the stripe topology, wherein the first node 121 and the second node 122 may be immediately adjacent.

The communications network 100 may, in some examples, be a 5G network or a 6G network.

In some embodiments, the first node 121 may be a first AP, e.g., AP l.

The method may comprise the following actions. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the first node 121 is depicted in FIG. 4. In FIG. 4, optional actions in some embodiments are represented with dashed lines. In some embodiments, the actions may be performed in a different order than that depicted FIG. 4.

### Action 401

### Uplink Pilots

To facilitate estimation of the uplink channels between each device of the one or more devices 130 and each node of the set of nodes 120, the one or more devices 130 may send pilots. It may be assumed that the one or more devices 130 may use K mutually orthogonal pilot sequences, of length τₚ, where τₚ≥K. One such pilot may be assigned to each of the K one or more devices 130. Examples herein may denote the k:th pilot sequence by φₖ. The pilots may be normalized, such that all of them may satisfy ∥φₖ∥²=1. Also, Φ=[φₗ . . . Φ_{K}] may be a matrix comprising all pilots.

During the pilot transmission, e.g., the pilot phase, the received signal at any of the set of nodes 120, such as the first node 121, e.g., AP l, may be understood to be:

Yₗ=\sqrt{pτₚ}HₗΦ^{H}+gₗs^{H}+Nₗ (1)
where pτₚ may be understood to be the normalized Signal-to-Noise Ratio (SNR), “transmit SNR”, gₗ may be understood to be the channel between the OoS interfering source and any of the set of nodes 120, such as the first node 121, e.g., AP l, s may be understood to be the OoS interference signal, and Nₗ may contain receiver noise at any of nodes in the set of nodes 120, such as the first node 121, e.g., AP l. Φ^{H} may be understood to denote the Hermitian transpose of Φ. s^{H} may be understood to denote the Hermitian transpose of s.

Each of the set of nodes 120, such as the first node 121, e.g., AP l, as will be explained in the next Action 402, may estimate the uplink channel Hₗ. It may also compute a residual signal, Zₗ, that may comprise estimation errors, noise and, parts of the, OoS interference.

The set of nodes 120, APs, may forward Zₗ, or a signal determined based on Zₗ, to the first network node 111, e.g., the CPU. In the preferred example, each of the set of nodes 120, e.g., each AP, may obtain a low-dimensional OoS interference signal estimate, [symbol] ₗ, based on Zₗ. These low-dimensional estimates may be then accumulated sequentially over the fronthaul of the communications network 100, e.g., the D-MIMO fronthaul, e.g., a radio stripe. In another example, the Gramians

$${Z}_{l}^{H} {Z}_{l}$$

may be computed at each of the set of nodes 120, e.g., each AP, and accumulated sequentially along the front-haul segments that may connect the set of nodes 120. In yet another example, Zₗ may be forwarded “as is” to the first network node 111.

In accordance with the foregoing, in this Action 401, the first node 121 obtains at least a first indication.

The first indication, e.g.,

$${Z}_{l - 1} , {\sum }_{i = 1}^{l - 1} {Z}_{i}^{H} {Z}_{i} , {\text{?}}_{( l - 1 )} ,$$

is of an interference signal, e.g., s. The first indication may be understood as a first, local, representation of an OoS interference signal, as described above in the description of the system model. For example, the first indication may be the residual signal, Zₗ, that may comprise estimation errors, noise and, parts of the, OoS interference.

The obtaining of the interference signal s is from the second node 122 operating in the communications network 100 and comprised in the set of nodes 120.

The interference signal s originates from the one or more interfering devices 140 outside of the communications network 100.

The obtaining in this Action 401 may be performed, e.g., via the second link 152, e.g., a wired link.

Obtaining may be understood as receiving, etc., e.g., via the second link 152.

That is, the first node 121 may receive the first indication from the second node 122, as the second node 122 may forward the first indication towards the first network node 111. This may be since the first node 121 may be adjacent to the second node 122 in a direction towards the first network node 111, e.g., in a stripe arrangement.

How the second node 122 may have obtained the first indication is described in the next Action 402 for the first node 121. It may be understood that every node in the set of nodes 120 may estimate their own residual signal, Zₗ, similarly. In other words, l or l−1 may be understood as relative terms based on a position a node in the set of nodes 120 may have in the arrangement, wherein any node may be considered to be l and its preceding node, in a direction towards the first network node 111, may be considered to be l−1.

### Action 402

As mentioned above, each of the set of nodes 120 may estimate the uplink channel Hₗ. Each of the set of nodes 120 may also compute a residual signal, Zₗ, that may comprise estimation errors, noise and, parts of the, OoS interference.

In accordance with the foregoing, in this Action 402, the first node 121 obtains a second indication.

The second indication

$${Z}_{l} , {\text{?}}_{l}^{o}$$

is of the interference signals. The second indication may be understood as a second, local, representation of the OoS interference signal.

The obtaining in this Action 402 of the second indication

$${Z}_{l} , {\text{?}}_{l}^{o}$$

of the interference signal s is from uplink measurements performed by the first node 121. The uplink measurements may be, e.g., from signals transmitted by the one or more devices 130. The signals transmitted by the one or more devices 130 may be, e.g., the uplink pilots described above.

Obtaining may be understood as calculating, determining, deriving, or similar.

Estimation of Channels from the One or More Devices 130 at the First Node 121, AP l

Based on Yₗ, the first node 121, e.g., AP l, may estimate the channel Hₗ. Since all of Hₗ, gₗ and s may be understood to be unknown, a least-squares (LS) fit one may for example use to estimate Hₗ, resulting in the estimate:

$$\begin{matrix}{\hat{H}}_{l} & = \frac{1}{\sqrt{p {τ}_{p}}} {Y}_{l} Φ \\ & = {H}_{l} + \frac{1}{\sqrt{p {τ}_{p}}} ( {g}_{l} {s}^{H} + {N}_{l} ) Φ\end{matrix} \qquad ( 2 )$$

This channel estimation may be performed independently at each of the set of nodes 120, e.g., each AP.

### Interference Channel Estimation

The next question may be how to estimate the OoS interferer channels, gₗ, which may be understood to be different for each of the set of nodes 120, e.g., each AP, and the interfering signal, s, which may be understood to be the same at all of the set of nodes 120, e.g., APs. As a preliminary, the following residual signal at the first node 121, e.g., AP l, may be defined as:

$$\begin{matrix}{Z}_{l} = {Y}_{l} - \sqrt{p {τ}_{p}} {\hat{H}}_{l} {Φ}^{H} \\ = ( {g}_{l} {s}^{H} + {N}_{l} ) ( I - {ΦΦ}^{H} ) \\ = ( {g}_{l} {s}^{H} + {N}_{l} ) P\end{matrix} \qquad ( 3 )$$

where P=I−ΦΦ^{H} may be understood to be the orthogonal projection matrix of pilot matrix Φ. This residual Zₗ may be computed by each of the set of nodes 120, e.g., each AP, independently. Here, τₚ>K may be required, otherwise Zₗ may be equal to zero so no information about s may be contained in Zₗ.

From (3), it may be noted that due to the non-invertibility of projection matrix P, the interfering signal s may not be estimated completely; only the part of s that may lie in the space spanned by P may eventually be estimated. Against this insight, the projector may be decomposed as P=ΨΨ^{H} where Ψ may be understood to be a tall matrix that may satisfy Ψ^{H}Ψ=I. This decomposition may be understood to be the economy-size-singular value decomposition (SVD). It may be noted that P may be understood to be of dimension τₚ×τₚ and may have a rank τₚ−K. Therefore, Ψ may be understood to be of dimensions τₚ×τₚ K, where τₚ>K. Examples of embodiments herein may then denote s̅=Ψ^{H}s; this may be understood to be the, lower-dimensional, part of s that actually may be estimated. To obtain an estimate s̅ of s̅, first the residual signal may be despread by computing:

$$\begin{matrix}{Z}_{l} Ψ = ( {g}_{l} {s}^{H} + {N}_{l} ) Ψ \\ = {g}_{1} {\overline{s}}^{H} + {N}_{l}^{′}\end{matrix} \qquad ( 4 )$$

where N′ₗ=NₗΨ may be understood to be an M×τₚ−K noise matrix. A direct calculation may show that the entries of N′ₗ may be independent and identically distributed (i.i.d) circularly symmetric Gaussian random variables.

In accordance with the foregoing, in some embodiments, the obtaining in this Action 402 of the second indication may be performed by subtracting from the uplink measurements performed by the first node 121, e.g., from signals transmitted by the one or more devices 130, an estimate of a received signal in the uplink measurements corresponding to only contributions from transmissions of known pilot sequences and noise.

In some embodiments, the obtaining in this Action 402 of the second indication may be performed according to the following formula:

$$\begin{matrix}{Z}_{l} = {Y}_{l} - \sqrt{p {τ}_{p}} {\hat{H}}_{l} {Φ}^{H} \\ = ( {g}_{l} {s}^{H} + {N}_{l} ) ( I - {ΦΦ}^{H} ) \\ = ( {g}_{l} {s}^{H} + {N}_{l} ) P\end{matrix} \qquad ( 3 )$$

where, e.g.,

Yₗ=\sqrt{pτₚ}HₗΦ^{H}+gₗs^{H}+Nₗ (1)

where, e.g.:

$$\begin{matrix}{\hat{H}}_{l} & = \frac{1}{\sqrt{p {τ}_{p}}} {Y}_{l} Φ \\ & = {H}_{l} + \frac{1}{\sqrt{p {τ}_{p}}} ( {g}_{l} {s}^{H} + {N}_{l} ) Φ\end{matrix} \qquad ( 2 )$$

and where, e.g., at least one of the following may apply:
K may be mutually orthogonal pilot sequences of length τₚ, transmitted by the one or more devices 130 operating in the communications network 100, wherein τₚ≥K, wherein one such pilot sequence may be assigned to each of the K one or more devices 130,
P=I−ΦΦ^{H} may be an orthogonal projection matrix of a pilot matrix Φ,
Φ=[φ₁ . . . φ_{K}] may be a matrix comprising all pilot sequences,
p may be transmit power, normalized,
pτₚ may be a normalized signal to interference noise ratio,
gₗ may be a first radio channel ĝₗ between the first node 121 and the one or more interfering devices 140,
s may be the interference signal,
Hₗ may be an estimation by the first node 121 of a second radio channel between the first node 121 and the one or more devices 130,
Φ^{H} may be understood to denote the Hermitian transpose of Φ,
s^{H} may be understood to denote the Hermitian transpose of s, and
Nₗ may indicate receiver noise at the first node 121.

In some embodiments, the pilot sequences may be normalized such that all of them satisfy ∥φₖ∥²=1.

In some embodiments, the obtaining in this Action 402 of the second indication may comprise applying a data compression algorithm.

The data compression algorithm may comprise a singular value decomposition in which only a leading singular vector component may be kept.

### Action 403

In this Action 403, the first node 121 determines a third indication.

Determining in this Action 403 may comprise calculating, deriving, estimating, etc.

The third indication

$${Z}_{l} , {Z}_{l}^{H} {Z}_{l} , {\sum }_{t = 1}^{L} {Z}_{l}^{H} {Z}_{l} , {\text{?}}_{l}$$

is of the interference signal s as a combination of the obtained first indication

$${Z}_{l - 1} , {\sum }_{i = 1}^{l - 1} {Z}_{i}^{H} {Z}_{i} , {\text{?}}_{( l - 1 )}$$

and the obtained second indication

$${Z}_{l} , {\text{?}}_{l}^{o} .$$

The third indication may be a third, combined, representation of the OoS interference signal.

Before describing any further the details on how the first node 121 may determine the third indication in this Action 303, it may be helpful to first consider two scenarios of how the local estimates of s̅ may be handled by APs in an arrangement such as that of the communications network 100, e.g., a radio stripe or RadioWeave arrangement, according to state of the art methods. s̅ may be understood to refer to as the estimation of s obtained e.g., by combining several low-dimensional OoS interference signal estimates, [symbol] ₗ, that each node in the set of nodes 120 may perform based on Zₗ. This is so that the benefits of Action 403 may be better understood by comparison. The “−” sign above s may be understood to denote, e.g., “average”, a kind of combining.

### Local Estimation of s̅ at Each AP, According to State of the Art

Considering that the interfering channel at AP l, gₗ, may be independent of other APs, each AP may obtain local estimates of gₗ. These estimates may be suboptimal since they may not exploit the fact that s may be the same at all APs. The best local estimate of s in the Least squares (LS) sense at AP l may be given by the minimizer of ∥ZₗΨ−gₗs̅^{H}∥, which may be the dominant right singular vector ZₗΨ.

In this method, each AP may make just local estimates of gₗ and s̅ and may not cooperate in joint processing of Zₗ.

This method may be understood to not be very good, but described here as a state-of-the-art (SOTA) baseline, so that the advantages of embodiments herein may be better understood.

### Estimation of s̅ by Forwarding all Residuals to the First Network Node 111, e.g., the CPU, According to Embodiments Herein

If all residuals Zₗ are forwarded on the fronthaul to first network node 111, e.g., the CPU, then the first network node 111, e.g., the CPU, may be able to estimate s by solving the following LS problem:

$${minimize}_{g , \overline{s}} {‖ Z Ψ - g {\overline{s}}^{H} ‖}_{F} \qquad ( 5 )$$

$$where Z = {[ \begin{matrix}{Z}_{1}^{T} & … & {Z}_{L}^{T}\end{matrix} ]}^{T} , and g = {[ \begin{matrix}{g}_{1}^{T} & … & {g}_{L}^{T}\end{matrix} ]}^{T} .$$

T may be understood to be the transpose operator. F may be understood to be the Frobenius, sometimes also denoted Euclidean, norm of a matrix. The solution may be given by the best rank-1 approximation of ZΨ, which in turn may be found using the SVD: specifically, the optimal estimates of g and s̅, up to a scaling factor, given by the left and right singular vectors of ZΨ. Equivalently, the estimate of s̅, up to a scaling factor, may be given by the dominant eigenvector of Ψ^{H}Z^{H}ZΨ.

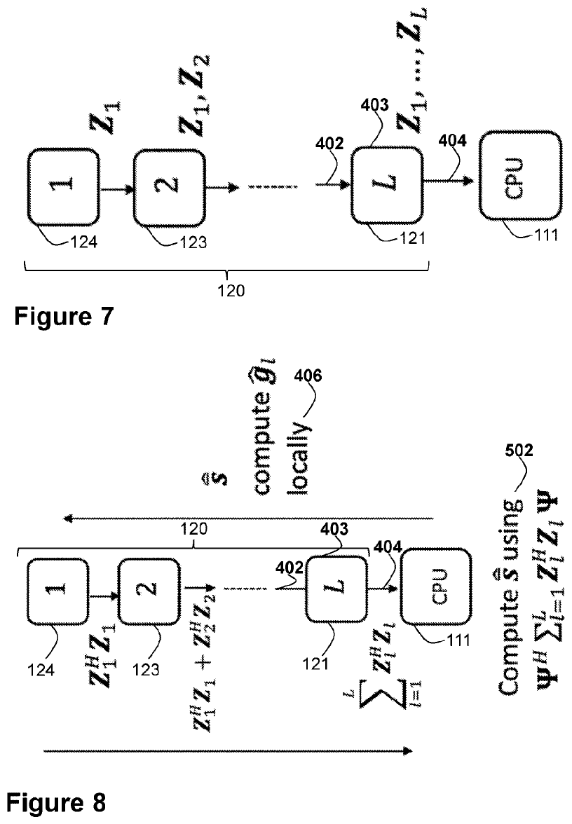

This approach may be understood to be performance-wise optimal, but highly inefficient: on a stripe topology it may require a significant fronthaul load. The first fronthaul segment may have to carry Z₁, the second segment may have to carry Z₁ and Z₂, the third segment may have to carry Z₁, Z₂ and Z₃, and so forth, see FIG. 7.

### Estimation of s̅ by Sequential Accumulation of Gramians, According to Embodiments Herein

An improvement over the method in the Section entitled “Estimation of s̅ by forwarding all residuals to the first network node 111, e.g., the CPU” may be achieved by sequentially accumulating Gramian matrices over the fronthaul. More specifically, since

$${Ψ}^{H} {Z}^{H} Z Ψ = {Ψ}^{H} ( {\sum }_{l = 1}^{L} {Z}_{l}^{H} {Z}_{l} ) Ψ \qquad ( 6 )$$

On e.g., a stripe topology, Ψ^{H}Z^{H}ZΨ may be computed sequentially: the first node 121, e.g., the l-th AP, may receive

$${\sum }_{i = 1}^{l - 1} = {Z}_{i}^{H} {Z}_{i}$$

from the second node 122, e.g., AP l−1, in Action 401 and may then add

$${Z}_{l}^{H} {Z}_{l}$$

as obtained in Action 402, and may forward, in this Action 403, to the next node, e.g., the next AP, in the set of nodes 120, e.g., the stripe. The last node, e.g., AP, which in the non-limiting example of FIG. 3 is the first node 111, may forward to the first network node 111, e.g., the CPU.

$${Z}_{i}^{H}$$

may be understood to denote the Hermitian transpose of Zᵢ.

The first network node 111, upon receiving

$${\sum }_{l = 1}^{L} {Z}_{l}^{H} {Z}_{l} ,$$

may then be enabled to obtain the optimal estimate of s̅, see FIG. 8, in accordance with Action 502.

The fronthaul load of this example may be understood to be lower than the method described in the Section entitled “Estimation of s by forwarding all residuals to the CPU” above, but it may be understood to be still significant. On a stripe topology, each fronthaul segment may have to carry a τₚ×τₚ-dimensional matrix.

### Estimation of s by Sequential Averaging and Phase Rotation, Preferred Example, According to Embodiments Herein

A significant improvement, in terms of fronthaul signaling load, over the method disclosed in the Section entitled “Estimation of s̅ by sequential accumulation of Gramians” may be obtained as follows—again, assuming a stripe topology.

Again, as explained in the Section entitled “Local estimation of s̅ at each AP”, considering that the OoS interfering channel at any of nodes in the set of nodes 120, such as the first node 121, e.g., AP l, gₗ, may be independent of other nodes in the set of nodes 120, e.g., APs, each node in the set of nodes 120, e.g., AP, may obtain local estimates of gₗ: the best local estimate of s̅ in the LS sense at any of nodes in the set of nodes 120, such as the first node 121, e.g., AP l, may be understood to be the dominant right singular vector ZₗΨ. In principle, these local estimates of s̅, obtained at the different nodes in the set of nodes 120, e.g., APs, may be simply averaged. Importantly, however, the dominant singular vector of a matrix may be understood to not be unique: it may be understood to be ambiguous up to an arbitrary phase rotation, that may depend on the inner workings of the actual SVD algorithm. Hence, in actuality, any of nodes in the set of nodes 120, such as the first node 121, e.g., AP l, may only estimate s up to an unknown phase rotation, so directly averaging local estimates obtained through the procedure just described may not work.

This problem may be solved by having any of nodes in the set of nodes 120, such as the first node 121, e.g., AP l, computing an average of the 3-estimate received from AP l−1 and adding its own local estimate with a phase-rotation that may be selected to “align” the two estimates. Mathematically:

$${\text{?}}_{l} = 0.5 ( {\text{?}}_{( l - 1 )} + {\text{?}}_{l}^{o} {e}^{j {α}_{l}} ) \qquad ( 8 )$$

where [symbol] ₗ may be understood to be the final estimate of s at any of nodes in the set of nodes 120, such as the first node 121, e.g., AP l, and forwarded to the next node in the set of nodes 120, e.g., AP l+1, wherein 4, such as the first node 121, e.g., AP l, and

$${α}_{l} = - arg ( {\text{?}}_{( l - 1 )}^{H} {\text{?}}_{l}^{o} )$$

may be understood to be the phase rotation needed to “align” [symbol] ₍ₗ₋₁₎ with

$${\text{?}}_{l}^{o} . {e}^{j {α}_{l}}$$

may be understood to denote Euler's number e to the power of jαₗ, where j may be understood to denote the imaginary unit (\sqrt{−1}).

It may be noted that in the non-limiting example of FIG. 3, the first node 121 is the last node of the set of nodes 120 prior to the first network node 111. However, for other examples, wherein the first node 121 may be an intermediate node in the set of nodes 120, that is, not immediately adjacent and preceding the first network node 111, the first node 121 may forward the third indication to another node in the set of nodes 120, which may be considered a “third node 123”, as opposed to a “first node 121” and a “second node 122”, other than the third node 123 as depicted in the non-limiting example of FIG. 3, where the third node 123 is depicted as preceding the second node 122 in the arrangement.

At the first node in the set of nodes 120, such as the fourth node 124 in FIG. 3, e.g., the first AP, embodiments herein may either initialize arbitrarily or initialize with [symbol] ₀=0.

The fronthaul cost of this scheme may be understood to be very small. Each fronthaul segment may have to carry only a τₚ-dimensional vector.

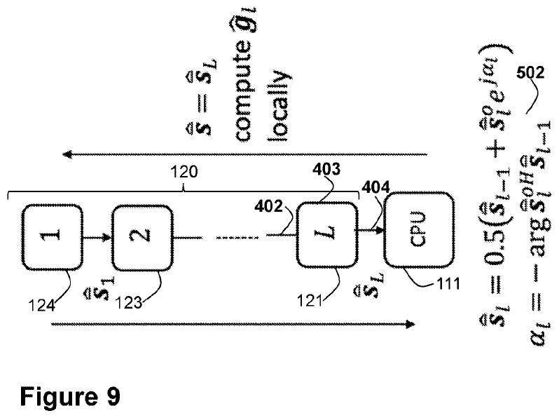

FIG. 9 is a schematic diagram depicting a preferred embodiment where the estimation of s may be achieved by sequential averaging and phase rotation.

In accordance with the foregoing,

In some embodiments, the determining in this Action 403 of the third indication [symbol] ₗ of the interference signal s may be performed by sequential averaging and phase rotation, e.g., according to the following formula:

$${\text{?}}_{l} = 0 \text{.5} ( {\text{?}}_{( l - 1 )} + {\text{?}}_{l}^{o} {e}^{j {α}_{l}} ) \qquad ( 8 )$$

Wherein, e.g., the phase rotation may be calculated based on the following formula:

$${α}_{l} = - arg ( {\text{?}}_{( l - 1 )}^{H} {\text{?}}_{l}^{o} ) , in order to “ align ” {\text{?}}_{( l - 1 )} with {\text{?}}_{l}^{o} .$$

$$where :$$

$${\text{?}}_{l}^{o}$$

may be understood to be the right singular vector of ZₗΨ computed at any of nodes in the set of nodes 120,
Ψ may be understood to be the decomposition of matrix P=I−ΦΦ^{H}, such that P=ΨΨ^{H}, where Ψ may be understood to be the tall matrix that may satisfy Ψ^{H}Ψ=I,
P=I−ΦΦ^{H} may be understood to be the orthogonal projection matrix of the pilot matrix Φ,
e^{jα}^{ᵢ} may be understood to denote Euler's number e to the power of jαₗ, and
j may be understood to denote an imaginary unit (\sqrt{−1}).

### Action 404

In this Action 404, the first node 121 sends the third indication.

The sending in this Action 405 of the third indication, e.g.,

$${Z}_{l} , {Z}_{l}^{H} {Z}_{l} , {\sum }_{l = 1}^{L} {Z}_{l}^{H} {Z}_{l} , {\text{?}}_{l}$$

is to the third node 123 operating in the communications network 100 and comprised in the set of nodes 120, or to the first network node 111 operating in the communications network 100 and having a connection to the set of nodes 120. As explained earlier, it may be noted that in the non-limiting example of FIG. 3, the first node 121 is the last node of the set of nodes 120 prior to the first network node 111. However, in other examples, wherein the first node 121 may be an intermediate node in the set of nodes 120, that is, not immediately adjacent and preceding the first network node 111, the first node 121 may forward the third indication to another node in the set of nodes 120, which may be considered a “third node 123”, as opposed to a “first node 121” and a “second node 122”, other than the third node 123 as depicted in the non-limiting example of FIG. 3, where the third node 123 is depicted as preceding the second node 122 in the arrangement. In other words, with the proviso the first node 121 may be immediately preceding the first network node 111, the first node 121 may send, in this Action 404, the third indication to the first network node 111. With the proviso the first node 121 may not be immediately preceding the first network node 111 in the set of nodes 120, the first node 121 may send, in this Action 404, the third indication to the third node 123. That is, the third node 123 understood as, in the set of nodes 120, the adjacent node to the first node 121 in the direction towards the first network node 111.

The sending in this Action 405 may be, e.g., transmitting, and may be performed, e.g., via the first link 151.

The first node 121 may be a first AP, the second node 122 may be a second AP and the third node 123 may be a third AP.

In some embodiments, the method may further comprise one or more of the following actions.

### Action 405

The first network node 111, e.g., the CPU, based on data from the set of nodes 120, e.g., all APs, that is, the residuals or on the low-dimensional signals based on them, may estimate s̅. The so-obtained estimate of s̅, [symbol] , may then be fed back over the fronthaul to the set of nodes 120, e.g., all APs.

In accordance with the foregoing, in this Action 405, the first node 121 may obtain a fourth indication.

The fourth indication [symbol] ₗ may be of the interference signal.

The obtaining in this Action 405 may be directly or indirectly, from the first network node 111, e.g., via the first link 151.

The fourth indication [symbol] ₗ may be based on an estimation of the interference signal by the first network node 111 based on at least the third indication

$${Z}_{l} , {Z}_{l}^{H} {Z}_{l} , {\sum }_{l = 1}^{L} {Z}_{l}^{H} {Z}_{l} , {\text{?}}_{l}$$

sent by the first node 121.

### Action 406

In this Action 406, the first node 121 may estimate, or determine a first radio channel.

The first radio channel ĝₗ may be between the first node 121 and the one or more interfering devices 140.

### Estimation of the OoS Interference Channel at Each AP

In accordance Action 405, once an estimate of s̅ may have been formed, it may be transmitted back to the set of nodes 120, e.g., all APs. Each node in the set of nodes 120, such as the first node 121, e.g., each AP, may then, in accordance with this Action 406, estimate the OoS interference channel. That is, after receiving the estimate [symbol] , each node in the set of nodes 120, such as the first node 121, e.g., each AP may obtain an estimate, ĝₗ, of their corresponding channel to the OoS interferer. This may be performed, for example, via least-squares:

ĝₗ=∥ [symbol] ∥⁻²ZₗΨ [symbol] ,l=1, . . . L (7)

### Action 407

The one or more devices 130, e.g., UEs, may now transmit data.

In this Action 407, the first node 121 may detect one or more uplink signals, e.g., one or more first uplink signals.

The one or more uplink signals may be from the one or more devices 130 operating in the communications network 100.

The detecting in this Action 407 may be using the estimated first radio channel jj and the fourth indication of the interference signal [symbol] , to perform suppression of interference.

That is, each node in the set of nodes 120, such as the first node 121, e.g., each AP, may then process the received uplink signals, treating the OoS interference as an unknown signal that may have propagated over the channels {ĝₗ}.

The detecting in this Action 407 may be, e.g., via the another respective links.

### Detection of Payload Data

During the payload phase, data may be detected either through central processing, e.g., maximum-ratio, zero-forcing, MMSE, . . . , or using any decentralized processing known in the art, e.g., [1,2]. In either case, the OoS interference signal may be simply treated as an additional unknown that may be eventually discarded.

More specifically, the received signal yₗ at AP l for a given symbol period may be given by:

$$\begin{matrix}{y}_{l} = {H}_{l} x + {g}_{l} s + {n}_{l} \\ = [ \begin{matrix}{H}_{l} & {g}_{l}\end{matrix} ] [ \begin{matrix}x \\ s\end{matrix} ] + {n}_{l}\end{matrix} \qquad ( 9 )$$

where x may be understood to be the payload transmitted by UEs, s may be understood to be the OoS sample, scalar value here, and nₗ may be understood to be the noise at the AP l.

The following subsections may be understood to be presented as further reference.

Embodiments of a method, performed by a first network node, such as the first network node 111, will now be described with reference to the flowchart depicted in FIG. 5. The method may be understood to be for handling the interference signal s. The first network node 111 operates in a wireless communications network, such as the communications network 100. The first network node 111 may be operating in the communications network 100 comprising the set of nodes 120 providing the segmented front-haul.

The method may be understood to be a computer-implemented method performed by the first network node 111.

In some embodiments, at least one of the following may apply: a) each of the nodes in the set of nodes 120 may be an AP, b) each of the nodes in the set of nodes 120 may have the respective plurality of antennas M, c) the communications network 100 may be a d-MIMO network, d) the first network node 111 may be a CPU of the d-MIMO network, e) the set of nodes 120 may be arranged with a stripe topology, and f) the set of nodes 120 may be arranged with a radioweave topology, and g) the set of nodes 120 may be arranged with the stripe topology, wherein the first node 121 and the second node 122 may be immediately adjacent.

The communications network 100 may, in some examples, be a 5G network or a 6G network.

The method may comprise one or more of the following actions. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the first network node 111 is depicted in FIG. 5. In FIG. 5, optional actions in some embodiments are represented with dashed lines. In some embodiments, the actions may be performed in a different order than that depicted FIG. 5.

The detailed description of some of the following corresponds to the same references provided above, in relation to the actions described for the first node 121 and will thus not be repeated here to simplify the description. For example, the third indication may be a third, combined, representation of an OoS interference signal.

### Action 501

In this Action 501, the first network node 111 obtains the third indication.

The third indication

$${Z}_{l} , {Z}_{l}^{H} {Z}_{l} , {\sum }_{l = 1}^{L} {Z}_{l}^{H} {Z}_{l} , {\text{?}}_{l}$$

is of the interference signal s. The interference signal s originates from the one or more interfering devices 140 outside of the communications network 100.

The obtaining in this Action 501 is from the first node 121 comprised in the set of nodes 120, e.g., via the first link 151.

The third indication

$${Z}_{l} , {Z}_{l}^{H} {Z}_{l} , {\sum }_{l = 1}^{L} {Z}_{l}^{H} {Z}_{l} , {\text{?}}_{l}$$

is of the interference signal s as the combination of at least the first indication

$${Z}_{l - 1} , {\sum }_{i = 1}^{l - 1} {Z}_{i}^{H} {Z}_{i} , {\text{?}}_{( l - 1 )}$$

of the interference signal s from the second node 122 operating in the communications network 100 and comprised in the set of nodes 120, and the second indication

$${Z}_{l} , {\text{?}}_{l}^{o}$$

of the interference signal s, as obtained by the first node 121 from the uplink measurements performed by the first node 121.

In some embodiments, the second indication may be obtained by subtracting from the uplink measurements performed by the first node 121 an estimate of a received signal in the uplink measurements corresponding to only contributions from transmissions of known pilot sequences and noise.

In some embodiments, the second indication may have been obtained according to the following formula:

$$\begin{matrix}{Z}_{l} = {Y}_{l} - \sqrt{p {τ}_{p}} {\hat{H}}_{l} {Φ}^{H} \\ = ( {g}_{l} {s}^{H} + {N}_{l} ) ( I - {ΦΦ}^{H} ) \\ = ( {g}_{l} {s}^{H} + {N}_{l} ) P\end{matrix} \qquad ( 3 )$$

where, e.g.:

Yₗ=\sqrt{pτₚ}HₗΦ^{H}+gₗs^{H}+Nₗ (1)

where, e.g.:

$$\begin{matrix}{\hat{H}}_{l} = \frac{1}{\sqrt{p {τ}_{p}}} {Y}_{l} Φ \\ = {H}_{l} + \frac{1}{\sqrt{p {τ}_{p}}} ( {g}_{l} {s}^{H} + {N}_{l} ) Φ\end{matrix} \qquad ( 2 )$$

and where, e.g., at least one of the following may apply:
K may be mutually orthogonal pilot sequences of length τₚ, transmitted by the one or more devices 130 operating in the communications network 100,
   wherein τₚ≥K, wherein one such pilot sequence may be assigned to each of the K one or more devices 130,
P=I−ΦΦ^{H} may be the orthogonal projection matrix of the pilot matrix Φ,
Φ=[Φ₁ . . . Φ_{K}] may be the matrix comprising all pilot sequences,
p may be transmit power, normalized,
pτₚ may be the normalized signal to interference noise ratio,
gₗ may be the first radio channel ĝₗ between the first node 121 and the one or more interfering devices 140,
s may be the interference signal,
Hₗ may be the estimation by the first node 121 of the second radio channel between the first node 121 and the one or more devices 130,
Φ^{H} may be understood to denote the Hermitian transpose of Φ,
s^{H} may be understood to denote the Hermitian transpose of s, and
Nₗ may indicate receiver noise at the first node 121.

In some embodiments, the pilot sequences may be normalized such that all of them satisfy ∥Φₖ∥²=1.

In some embodiments, the third indication [symbol] ₗ of the interference signal s may be determined by sequential averaging and phase rotation, e.g., according to the following formula:

$${\text{?}}_{l} = 0.5 ( {\text{?}}_{( l - 1 )} + {\text{?}}_{l}^{o} {e}^{j {α}_{l}} ) \qquad ( 8 )$$

wherein, e.g., the phase rotation may be calculated based on the following formula:

$${α}_{l} = - arg ( {\text{?}}_{( l - 1 )}^{H} {\text{?}}_{l}^{o} ) , in order to {}^{‶} {align}^{″} {\text{?}}_{( l - 1 )} with {\text{?}}_{l}^{o} .$$

$$where :$$

$${\text{?}}_{l}^{o}$$

may be understood to be the right singular vector of ZₗΨ computed at any of nodes in the set of nodes (120),
Ψ may be understood to be the decomposition of the matrix P=I−ΦΦ^{H}, such that P=ΨΨ^{H}, where Ψ is the tall matrix that may satisfy Ψ^{H}Ψ=I,
P=I−ΦΦ^{H} may be understood to be the orthogonal projection matrix of the pilot matrix Φ,
e^{jα}^{ₗ} may be understood to denote Euler's number e to the power of jαₗ, and
j may be understood to denote the imaginary unit (\sqrt{−1}).

In some embodiments, the data compression algorithm may have been applied to the second indication.

The data compression algorithm may comprise the singular value decomposition in which only the leading singular vector component may be kept.

### Action 502

In this Action 502, the first network node 111 determines the fourth indication.

Determining in this Action 401 may comprise calculating, estimating, deriving, or similar.

The fourth indication [symbol] ₗ is of the interference signal.

The fourth indication [symbol] ₗ is based on the estimation of the interference signal by the first network node 111 based on at least the third indication

$${Z}_{l} , {Z}_{l}^{H} {Z}_{l} , {\sum }_{l = 1}^{L} {Z}_{l}^{H} {Z}_{l} , {\text{?}}_{l}$$

obtained from the first node 121.

In some embodiments, the determining in this Action 502 of the fourth indication [symbol] ₗ may be performed by first dispreading the interference signal according to the following formula:

$$\begin{matrix}{Z}_{l} Ψ = ( {g}_{l} {s}^{H} + {N}_{l} ) Ψ \\ = {g}_{1} {\overline{s}}^{H} + {N}_{l}^{′}\end{matrix} \qquad ( 4 )$$

where:
ZₗΨ may be understood to be a dominant right singular vector,
gₗ may be the a first radio channel ĝₗ between the first node 121 and one or more interfering devices 140,
s^{H} may be understood to denote the Hermitian transpose of s,
N′ₗ=NₗΨ may be an M×τₚ−K noise matrix,
K may be understood to be the mutually orthogonal pilot sequences of length τₚ, transmitted by the one or more devices 130 operating in the communications network (100), wherein τₚ≥K,
Ψ may be understood to be the decomposition of the matrix P=I−ΦΦ^{H}, such that P=ΨΨ^{H}, where Ψ may be understood to be the tall matrix that may satisfy Ψ^{H}Ψ=I, and
P=I−ΦΦ^{H} may be understood to be the orthogonal projection matrix of the pilot matrix Φ.

In some embodiments, the determining in this Action 502 of the fourth indication [symbol] ₗ may be performed by solving a least squares problem according to the following formula:

$${minimize}_{g , \overline{s}} {‖ Z Ψ - g {\overline{s}}^{H} ‖}_{F} \qquad ( 5 )$$

where:
g may be understood to be a first radio channel between the set of nodes 120 and one or more interfering devices 140,
s̅ may be understood to be an estimate the interference signal,
Zₗ Ψ may be understood to be a dominant right singular vector,
s̅^{H} is an estimate the interference signal in the second radio channel between the set of nodes 120 and the one or more devices 130,

$$Z = {[ \begin{matrix}{Z}_{1}^{T} & … & {Z}_{L}^{T}\end{matrix} ]}^{T} , and$$

$$g = {[ \begin{matrix}{g}_{1}^{T} & … & {g}_{L}^{T}\end{matrix} ]}^{T} ,$$

T may be understood to be the transpose operator,
F may be understood to be the Frobenius norm,
Ψ may be understood to be the decomposition of the matrix P=I−ΦΦ^{H} such that P=ΨΨ^{H}, where W may be understood to be the tall matrix that may satisfy Ψ^{H}Ψ=I, and
P=I−ΦΦ^{H} may be understood to be the orthogonal projection matrix of the pilot matrix Φ, and
   the solution may be given by the best rank-1 approximation of ZΨ, and the estimate of s may be given by the dominant eigenvector of Ψ^{H}Z^{H}ZΨ.

### Centralized Processing

With centralized processing, the joint estimation of desired and OoS interference signal may be obtained by least-squares, e.g., zero-forcing:

$$[ \begin{matrix}\hat{x} \\ \hat{s}\end{matrix} ] = {[ \begin{matrix}\hat{H} & \hat{g}\end{matrix} ]}^{†} y \qquad ( 10 )$$

where \hat{x} may be understood to be the desired estimate of x, ŝ may be understood to be the estimate of s,

$$y = {[ \begin{matrix}{y}_{1}^{T} & … & {y}_{L}^{T}\end{matrix} ]}^{T}$$

and (⋅)^{†} may be understood to be the pseudoinverse of the argument. ŝ may typically be discarded, as the OoS interference signal may be understood to carry no information.

### Sequential Least Squares

With sequential least-squares, e.g., zero-forcing, it may be noted that the LS estimate of the desired signal and interfering signal at AP l may be written as:

$$[ \begin{matrix}{\hat{x}}_{l} \\ {\hat{s}}_{l}\end{matrix} ] = [ \begin{matrix}{\hat{x}}_{l - 1} \\ {\hat{s}}_{l - 1}\end{matrix} ] + {T}_{l} ( {y}_{l} - {\hat{H}}_{l} {\hat{x}}_{l - 1} - {\hat{g}}_{l} {\text{?}}_{l - 1} ) , l = 1 , … , L , \qquad ( 11 )$$

where

Tₗ=Pₗ₋₁[Ĥₗĝₗ]^{H}([Ĥₗĝₗ]Pₗ₋₁[Ĥₗĝₗ]^{H}+σ²I)⁻¹

and

Pₗ=(I−Tₗ[Ĥₗĝₗ])Pₗ₋₁

and initial values

$$[ \begin{matrix}{\hat{x}}_{l} \\ {\hat{s}}_{l}\end{matrix} ] = [ \begin{matrix}0 \\ 0\end{matrix} ]$$

and P₀=αI with α being a large constant.

### Action 503

The first network node 111 in this Action 503, sends, or provides, the fourth indication.

The sending in this Action 503 is, directly or indirectly, to the first node 121.

The sending in this Action 503 of the fourth indication may be to all of the nodes comprised in the set of nodes 120, e.g., the first node 121 and the second node 122. The first network node 111 may send the fourth indication first to the node of the set of nodes 120 immediately adjacent to the it, such as in some examples, the first node 121. The first node 121 may then forward the fourth indication to the next node in the set of nodes 120 immediately adjacent to the first node 121, in the direction opposite to the first network node 111, in this case, the second node 122, and the second node 122 may forward the fourth indication to the next adjacent node in the set of nodes 120, in some examples, the third node 123, and so and so forth, until the fourth indication reaches the last node in the set of nodes 120.

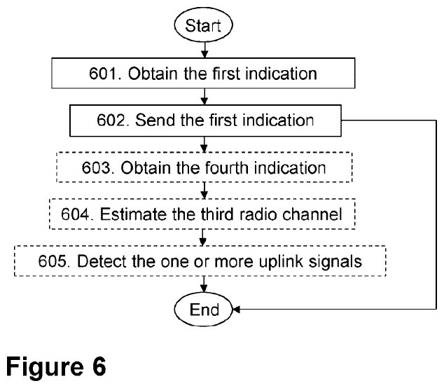

Embodiments of a method, performed by a second node, such as the second node 122, will now be described with reference to the flowchart depicted in FIG. 6. The method may be understood to be for handling the interference signal s. The second node 122 operates in in a communications network, such as the communications network 100. The second node 122 is comprised in the set of nodes 120 providing a segmented front-haul.

The method may be understood to be a computer-implemented method performed by the second node 112.

In some embodiments, at least one of the following may apply: a) each of the nodes in the set of nodes 120 may be an AP, b) each of the nodes in the set of nodes 120 may have the respective plurality of antennas M, c) the communications network 100 may be a d-MIMO network, d) the first network node 111 may be a CPU of the d-MIMO network, e) the set of nodes 120 may be arranged with a stripe topology, and f) the set of nodes 120 may be arranged with a radioweave topology, and g) the set of nodes 120 may be arranged with the stripe topology, wherein the first node 121 and the second node 122 may be immediately adjacent.

The communications network 100 may, in some examples, be a 5G network or a 6G network.

The method may comprise one or more of the following actions. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the second node 122 is depicted in FIG. 6. In FIG. 6, optional actions in some embodiments may be represented with dashed lines. In some embodiments, the actions may be performed in a different order than that depicted FIG. 6.

The detailed description of some of the following corresponds to the same references provided above, in relation to the actions described for the first node 121 and will thus not be repeated here to simplify the description. For example, the third indication may be a third, combined, representation of an OoS interference signal.

### Action 601

In this Action 601, the second node 122 obtains the first indication.

The first indication

$${Z}_{l} , {\text{?}}_{l}^{o}$$

is of the interference signal s. The first indication may be understood as a first local representation of the OoS interference signal.

The obtaining of the interference signal s is from uplink measurements performed by the second node 122.

The interference signal s originates from the one or more interfering devices 140 outside of the communications network 100.

In some embodiments, the obtaining in this Action 601 of the first indication may be performed by subtracting from the uplink measurements performed by the second node 122 an estimate of a received signal in the uplink measurements corresponding to only contributions from transmissions of known pilot sequences and noise.

In some embodiments, the obtaining in this Action 601 of the first indication may be performed according to the following formula:

$$\begin{matrix}{Z}_{l} = {Y}_{l} - \sqrt{p {τ}_{p}} {\hat{H}}_{l} {Φ}^{H} \\ = ( {g}_{l} {s}^{H} + {N}_{l} ) ( I - {ΦΦ}^{H} ) \\ = ( {g}_{l} {s}^{H} + {N}_{l} ) P\end{matrix} \qquad ( 3 )$$

where, e.g.:

Yₗ=\sqrt{pτₚ}HₗΦ^{H}+gₗs^{H}+Nₗ (1)

where, e.g.:

$$\begin{matrix}{\hat{H}}_{l} = \frac{1}{\sqrt{p {τ}_{p}}} {Y}_{l} Φ \\ = {H}_{l} + \frac{1}{\sqrt{p {τ}_{p}}} ( {g}_{l} {s}^{H} + {N}_{l} ) Φ\end{matrix} \qquad ( 2 )$$

and where, e.g., at least one of the following may apply:
K may be mutually orthogonal pilot sequences of length τₚ, transmitted by one or more devices 130 operating in the communications network 100, wherein τₚ≥K, wherein one such pilot sequence may be assigned to each of the K one or more devices 130,
P=I−ΦΦ^{H} may be an orthogonal projection matrix of the pilot matrix (D,
Φ=[φ₁ . . . φ_{K}] may be the matrix comprising all pilot sequences,
p may be transmit power, normalized,
pτₚ may be a normalized signal to interference noise ratio,
gₗ may be the third radio channel ĝₗ, between the second node 122 and the one or more interfering devices 140,
s may be the interference signal,
Hₗ may be the estimation by the second node 122 of a fourth radio channel between the second node 122 and the one or more devices 130,
Ĥₗ may be the estimation by the first node 121 of the second radio channel between the first node 121 and the one or more devices 130,
Φ^{H} may be understood to denote the Hermitian transpose of Φ,
s^{H} may be understood to denote the Hermitian transpose of s, and
Nₗ may indicate receiver noise at the second node 122.

In some embodiments, the pilot sequences may be normalized such that all of them satisfy ∥φₖ∥²=1.

In some embodiments, the obtaining in this Action 601 of the first indication may comprise applying a data compression algorithm.

In some embodiments, the data compression algorithm may comprise the singular value decomposition in which only the leading singular vector component may be kept.

### Action 602

In this Action 602, the second node 122 sends the first indication.

The sending in this Action 602 of the first indication

$${Z}_{l} , {\text{?}}_{l}^{o}$$

is to the first node 121 operating in the communications network 100 and comprised in the set of nodes 120.

The sending in this Action 602 may be, e.g., transmitting, and may be performed, e.g., via the second link 152.

The sending in this Action 602 of the first indication

$${Z}_{l} , {\text{?}}_{l}^{o}$$

may be to the first node 121 operating in the communications network 100 and comprised in the set of nodes 120.

The sending in this Action 602 may be, e.g., transmitting, and may be performed, e.g., via the second link 152.

In some embodiments, the method may further comprise one or more of the following actions:

### Action 603

The second node 122 in this Action 603, may obtain the fourth indication.

The fourth indication [symbol] ₗ may be of the interference signal.

The obtaining in this Action 603 may be directly or indirectly, from the first network node 111, e.g., via the first link 151 and the second link 152.

The fourth indication [symbol] ₗ may be based on the estimation of the interference signal by the first network node 111 based on at least the first indication

$${Z}_{l} , {\text{?}}_{l}^{o}$$

sent by the second node 122.

In some embodiments, the obtained fourth indication [symbol] ₗ of the interference signal may be further based on the third indication

$${Z}_{l} , {Z}_{l}^{H} {Z}_{l} , {\sum }_{l = 1}^{L} {Z}_{l}^{H} {Z}_{l} , {\text{?}}_{l}$$

of the interference signals. The third indication

$${Z}_{l} , {Z}_{l}^{H} {Z}_{l} , {\sum }_{l = 1}^{L} {Z}_{l}^{H} {Z}_{l} , {\text{?}}_{l}$$

of the interference signal s may have been determined by the first node 121 as the combination of the sent first indication

$${Z}_{l - 1} , {\sum }_{i = 1}^{l - 1} {Z}_{i}^{H} {Z}_{i} , {\text{?}}_{( l - 1 )}$$

and the second indication

$${Z}_{l} , {\text{?}}_{l}^{o}$$

of the interference signal s, obtained by the first node 121 from uplink measurements performed by the first node 121.

In some embodiments, the third indication [symbol] ₗ of the interference signal s may have been determined by sequential averaging and phase rotation, e.g., according to the following formula:

$${\text{?}}_{l} = 0.5 ( {\text{?}}_{( l - 1 )} + {\text{?}}_{l}^{o} {e}^{j {α}_{l}} ) \qquad ( 8 )$$

Wherein, e.g., the phase rotation may be calculated based on the following formula:

$${α}_{l} = - arg ( {\text{?}}_{( l - 1 )}^{H} {\text{?}}_{l}^{o} ) , in order to “ align ” {\text{?}}_{( l - 1 )} with {\text{?}}_{l}^{o} .$$

$$where :$$

$${\text{?}}_{l}^{o}$$

may be understood to be the right singular vector of ZₗΨ computed at any of nodes in the set of nodes (120),
Ψ may be understood to be the decomposition of the matrix P=I−ΦΦ^{H} such that P=ΨΨ^{H}, where Ψ may be understood to be the tall matrix that may satisfy Ψ^{H}Ψ=I, and
P=I−ΦΦ^{H} may be understood to be the orthogonal projection matrix of the pilot matrix Φ,
e^{jα}^{ₗ} may be understood to denote Euler's number e to the power of jαₗ, and
j may be understood to denote the imaginary unit (\sqrt{−1}).

In some embodiments, the method may further comprise one or more of the following actions:

### Action 604

In this Action 604, the second node 122 may estimate, or determine, a third radio channel.

The third radio channel ĝₗ may be between the second node 122 and the one or more interfering devices 140.

### Action 605

In this Action 605, the second node 122 may detect one or more uplink signals, e.g., one or more second uplink signals.

The one or more uplink signals may be from the one or more devices 130 operating in the communications network 100.

The detecting in this Action 605 may be using the estimated third radio channel ĝₗ and the fourth indication of the interference signal [symbol] ₗ to perform suppression of interference.

The detecting in this Action 605 may be, e.g., via the another respective links.

Embodiments herein may also relate to a computer-implemented method, performed by the communications network 100, comprising the first node 121, the first network node 111 and the second node 122, respectively performing the methods according to any of FIGS. 4-6, that is, any of Actions 401-407, 501-503 and 601-605. An overview of such a method will now be illustrated with a non-limiting example wherein the set of nodes 120 may be APs, the one or more devices 130 may be UEs and the first network node 111 may be a CPU.

### Overall Protocol and Algorithm Architecture

The overall protocol of embodiments herein may work as follows:
1. To facilitate estimation of the uplink channels between each UE and each AP, the UEs may send pilots. It may be assumed that they may use K mutually orthogonal pilot sequences, of length τₚ, where τₚ≥K. One such pilot may be assigned to each of the K UEs. Embodiments herein may denote the k:th pilot sequence by φₖ. The pilots may be normalized, such that all of them may satisfy ∥φₖ∥²=1. Also, Φ=[φ₁ . . . φ_{K}] may be a matrix comprising all pilots.
   During the pilot transmission, the received signal at AP l may be understood to be

Yₗ=\sqrt{pτₚ}HₗΦ^{H}+gₗs^{H}+Nₗ (1)
where pτₚ may be understood to be the normalized Signal-to-Noise Ratio (SNR), “transmit SNR”, gₗ may be understood to be the channel between the OoS interfering source and AP l, s may be understood to be the OoS interference signal, and Nₗ may contain receiver noise at AP l.
2. Each AP, l, may, according to Action 402, estimate the uplink channel Hₗ. It may also compute a residual signal, Zₗ, that may comprise estimation errors, noise and, parts of the, OoS interference.
3. The APs, according to Action 401 and Action 403, may forward Zₗ, or a signal determined based on Zₗ, to the CPU. In the preferred example, each AP may obtain a low-dimensional OoS interference signal estimate, [symbol] ₗ, based on Zₗ. These low-dimensional estimates may be then accumulated sequentially over the D-MIMO fronthaul, e.g., a radio stripe. In another example, the Gramians

$${Z}_{l}^{H} {Z}_{l}$$

may be computed at each AP, and accumulated sequentially along the front-haul segments that may connect the APs. In yet another example, Zₗ may be forwarded “as is” to the CPU.
4. The CPU, according to Action 502, based on data from all APs, that is, the residuals or on the low-dimensional signals based on them, may estimate s̅. The so-obtained estimate of s̅, [symbol] , may be fed back over the fronthaul to all APs.
5. After receiving the estimate [symbol] , each AP, according to Action 406, may obtain an estimate, ĝₗ, of their corresponding channel to the OoS interferer.
6. The UEs may now transmit data. Each AP may, according to Action 407, process the received uplink signals, treating the OoS interference as an unknown signal that may have propagated over the channels {ĝₗ}.

FIG. 7 is a schematic diagram illustrating an example of embodiments herein, where the estimation of s̅ may be achieved by forwarding all residuals to the first network node 111, e.g., a CPU. The set of nodes 120 is depicted as comprising L nodes arranged in a stripe, where node 1 is the fourth node 124, node 2 is the third node 123, and after a number of intermediate nodes, depicted as suspensive points, node L is the first node 111, adjacent to the CPU. As depicted, and in a similar manner as described for the first node 111 in Action 402, node 1 in the arrangement calculates its own “second indication” as Z₁ and forwards the second indication to node 2. Node 2, in a similar manner as described for the first node 111 in Action 401, obtains Z₁ as its “first indication”, and in a similar manner as described for the first node 111 in Action 402, calculates its own “second indication” as Z₂. Then, in a similar manner as described for the first node 111 in Action 403, node 2 determines its own “third indication”, Z₁, Z₂ and forwards it to the next node in the set of nodes 120 towards the CPU. This next node is not depicted in FIG. 7. The last node L in the set of nodes 120, the first node 111, calculates its own second indication in Action 402, as Z_{L}. Then, having obtained the second indication from the node in the set of nodes 120 immediately preceding it, according to Action 401, determines the third indication in accordance with Action 403 as Z₁, . . . Z_{L} and forwards it to the CPU in accordance with Action 404.

FIG. 8 is a schematic diagram illustrating an example of embodiments herein, where the estimation of s may be achieved by sequential accumulation of Gramians. The set of nodes 120 and the first network node 111 are depicted as described in FIG. 7. As depicted, and in a similar manner as described for the first node 111 in Action 402, node 1 in the arrangement calculates its own “second indication” as

$${Z}_{1}^{H} {Z}_{1}$$

and forwards the second indication to node 2. Node 2, in a similar manner as described for the first node 111 in Action 401, obtains

$${Z}_{1}^{H} {Z}_{1}$$

as its “first indication”, and in a similar manner as described for the first node 111 in Action 402, calculates its own “second indication” as

$${Z}_{2}^{H} {Z}_{2} .$$

Then, in a similar manner as described for the first node 111 in Action 403, node 2 determines its own “third indication” as

$${Z}_{1}^{H} {Z}_{1} + {Z}_{2}^{H} {Z}_{2}$$

and forwards it to the next node in the set of nodes 120 towards the CPU. This next node is not depicted in FIG. 8. The last node L in the set of nodes 120, the first node 111, calculates its own second indication in Action 402, as

$${Z}_{L}^{H} {Z}_{L} .$$

Then, having obtained the second indication from the node in the set of nodes 120 immediately preceding it, according to Action 401, determines the third indication in accordance with Action 403 as

$${\sum }_{l = 1}^{L} {Z}_{l}^{H} {Z}_{l}$$

and forwards it to the CPU in accordance with Action 404. The first network node 111, then, in accordance with Action 502, may compute the fourth indication, [symbol] , using

$${Ψ}^{H} ( {\sum }_{l = 1}^{L} {Z}_{l}^{H} {Z}_{l} ) Ψ$$

and send it to the first node 121, according to Action 503. Each of the nodes in the set of nodes 120, may, in a similar manner as described for the first node 111 in Action 405, receive the fourth indication, and in a similar manner as described for the first node 111 in Action 406, compute ĝₗ locally using the fourth indication, [symbol] . FIG. 9 is a schematic diagram depicting a preferred embodiment where the estimation of s may be achieved by sequential averaging and phase rotation. The set of nodes 120 and the first network node 111 are depicted as described in FIG. 7. As depicted, and in a similar manner as described for the first node 111 in Action 402 node 1 in the arrangement calculates its own “second indication” as [symbol] ₁ and forwards the second indication to node 2. Node 2, in a similar manner as described for the first node 111 in Action 401, obtains [symbol] ₁ as its “first indication”, and in a similar manner as described for the first node 111 in Action 402, calculates its own “second indication” as

$${\text{?}}_{2}^{o} .$$

Then, in a similar manner as described for the first node 111 in Action 403, node 2 determines its own “third indication” as [symbol] ₂ and forwards it to the next node in the set of nodes 120 towards the CPU. This next node is not depicted in FIG. 9. The last node L in the set of nodes 120, the first node 111, calculates its own second indication in Action 402, as

$${\text{?}}_{1}^{o} .$$

Then, having obtained the second indication from the node in the set of nodes 120 immediately preceding it, according to Action 401, determines the third indication in accordance with Action 403 as [symbol] _{L} and forwards it to the CPU in accordance with Action 404. The first network node 111, then, in accordance with Action 502, may compute the fourth indication, [symbol] ₗ, using

$${\text{?}}_{l} = 0.5 ( {\text{?}}_{( l - 1 )} + {\text{?}}_{l}^{o} {e}^{{j α}_{l}} ) where {α}_{l} = - arg ( {\text{?}}_{( l )}^{oH} {\text{?}}_{l - 1} )$$

and send it to the first node 121, according to Action 503. Each of the nodes in the set of nodes 120, may, in a similar manner as described for the first node 111 in Action 405, receive the fourth indication, and in a similar manner as described for the first node 111 in Action 406, compute ĝₗ locally using the fourth indication, [symbol] , wherein [symbol] ₗ= [symbol] _{L}. That is, for the last node in the set of nodes 120, the local index “I” may be understood to be the same as the global index “L”.

### Numerical Example

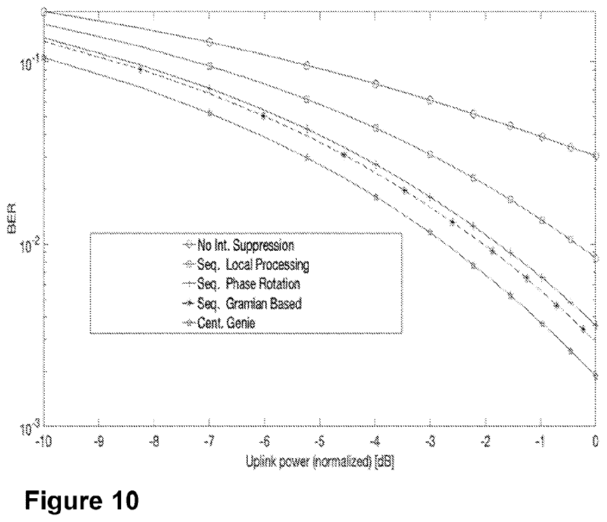

The capability of embodiments herein may be illustrated through numerical results. FIG. 10 is a graph illustrating the results. The propagation model may be the 3GPP Urban Microcell model with 2 GHz carrier frequency and large-scale fading coefficients

$${β}_{kl} = - 30.5 - 36.7 {log}_{10} ( \frac{{d}_{kl}}{1 m} ) , \qquad ( 12 )$$

where dₖₗ may be understood to be the distance between a node in the set of nodes 120, e.g., AP l, and a device of the one or more devices 130, e.g., UE k. This example of embodiments herein may consider a uniform linear array at each node in the set of nodes 120, e.g., AP, with half-wavelength antenna spacing. The number of nodes in the set of nodes 120, e.g., APs, may be understood to be L=4, the number of antennas per node in the set of nodes 120, e.g., AP, may be understood to be M=4 in this example, the number of devices in the one or more devices 130, e.g., users, served may be understood to be K=5, and there may be one OoS interference source. Quadrature phase shift keying (QPSK) modulation may be used for the transmission, and the fading may be uncorrelated Rayleigh. In FIG. 10, the different curves may be understood to be as follows:
No interference suppression, represented as “No Int. Suppression”: This may be understood to be the baseline without any attempts to suppress the OoS interference. This may be implemented either centralized or using decentralized implementation, e.g., Kalman filter approach, see e.g. [2].
Sequential local processing, represented as “Seq. Local Processing” (Section entitled “Local estimation of s̅ at each AP”): Each AP may form local estimates of the channels to the UEs and to the OoS interferer. This method may not exploit the fact that all APs see the same OoS interference signal.
Sequential Gramian based, represented as “Seq. Phase Rotation” (the Section entitled “Estimation of s̅ by forwarding all residuals to the CPU”: This may be understood to be the distributed OoS interference suppression method using the accumulation-of-Gramians method for the OoS interference channel estimation. This is, performance-wise, equivalent to centralized processing if all data from all APs are collected at the CPU.
Sequential phase rotation, represented as “Seq. Gramian Based” (the Section entitled “Estimation of s̅ by sequential accumulation of Gramians”): This is the distributed OoS interference suppression method using the sequential-phase-rotation method for the OoS interference channel estimation. Note the small performance loss compared to the Section entitled “Estimation of s̅ by forwarding all residuals to the CPU”, while the savings in fronthaul may be substantial.
Centralized genie detector, represented as “Cent. Genie”: This may be understood to be a baseline, genie, case where centralized processing may be performed with perfect knowledge of all channels of the UEs and the OoS interferer (i.e. {Hₗ, gₗ}, l=1, . . . , L).

The detection of symbols may be performed done using a nearest-point detector on the processed signal. The Bit error rate (BER) curve may be understood to represent an average over noise and channel fading. As may be concluded from FIG. 10, the BER decreases as the uplink power (depicted in dB, normalized), increases. The decrease in BER is consistently largest with the centralized genie detector, and smallest with no interference suppression. Each of the methods according to embodiments herein decreases the BER with respect to when than no suppression is performed. The sequential local processing shows the lowest suppression of the methods of embodiments herein and the sequential Gramian based method, the largest decrease. However, sequential phase rotation, which shows a similar, albeit smaller decrease than the sequential Gramian based method, achieves the decrease with savings in fronthaul.

As a summary of the foregoing with a few non-limiting illustrative examples, embodiments herein may be understood to relate to the following non-limiting examples:

Example 1. A D-MIMO system with at least a first access point (AP), which may be understood to correspond to the first node 121, and a second AP, which may be understood to correspond to the second node 122, and a central processing unit (CPU), which may be understood to correspond to the first network node 111, performing uplink reception of signals from one or more user equipment's (UEs) in the presence of an out-of-system (OoS) interferer, comprising the steps of:
the second AP:
   obtains, from uplink measurements, a first local representation of the OoS interference signal,
   forwards the first (local) OoS interference representation to the first AP,
the first AP:
   receives (at least) one OoS interference representation from (at least) a second AP,
   obtains, from uplink measurements, a second (local) representation of an OoS interference signal,
   determines a third (combined) representation of an OoS interference signal based on the (at least one) received and the local OoS interference signal representations,
   forwards the third (combined) representation of an OoS interference signal to the CPU or to a third AP,
the CPU
   receives at least one (combined) representation of an OoS interference signal from at least one AP,
   determines an estimate of the OoS interference signal, based on the (at least one) received representations of the OoS interference signal,
   forwards the estimate of the OoS interference signal to (at least) the first and the second APs.

Example 2. Method above where the first and second APs receive the estimate of the OoS interference signal from the CPU, estimate a channel from the OoS interferer, and use sequential processing methods for detection of uplink signals from the UEs, treating the OoS interferer as an unknown interfering signal.

Example 3. Method above, where the calculation of the first and second local representation of the OoS signals comprises methods from the Sections entitled “Overall protocol and algorithm architecture”, “Interference channel estimation”, or “Local estimation of s̅ at each AP”.

Example 4. Any method above, where the combining comprises methods from the Sections entitled “Estimation of s̅ by forwarding all residuals to the CPU”, “Estimation of s̅ by sequential accumulation of Gramians” or “Estimation of s by sequential averaging and phase rotation (preferred example)”. The Section entitled “Estimation of s by sequential averaging and phase rotation (preferred example) may be understood to be preferred.

Certain embodiments disclosed herein may provide one or more of the following technical advantage(s), which may be summarized as follows.

Embodiments herein, may be understood to enable suppression of OoS interference in D-MIMO through distributed signal processing, at a much lower fronthaul cost than existing solutions, and at a marginal performance loss compared to fully centralized processing.

The reduced fronthaul requirement may have direct impact on cost and energy efficiency of the system.

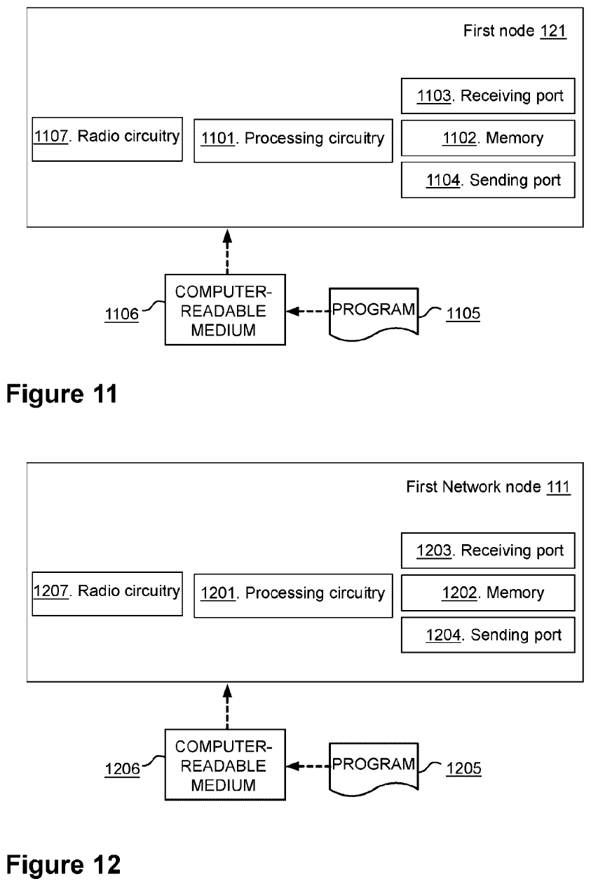

FIG. 11 depicts an example of the arrangement that the first node 121 may comprise to perform the method actions described above in relation to FIG. 4 and/or FIGS. 7-10. The first node 121 may be understood to be for handling the interference signal s. The first node 121 is configured to operate in the communications network 100. The first node 121 is configured to be comprised in the set of nodes 120 configured to provide the segmented front-haul.

In some embodiments, at least one of the following may apply: a) each of the nodes in the set of nodes 120 may be configured to be an AP, b) each of the nodes in the set of nodes 120 may be configured to have the respective plurality of antennas M, c) the communications network 100 may be configured to be a d-MIMO, network, d) the first network node 111 may be configured to be a CPU d-MIMO network, e) the set of nodes 120 may be configured to be arranged with a stripe topology, f) the set of nodes 120 may be configured to be arranged with a radioweave topology, and g) the set of nodes 120 may be configured to be arranged with a stripe topology, wherein the first node 121 and the second node 122 may be configured to be immediately adjacent.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 121 and will thus not be repeated here. For example, the third indication may be configured to be a third, combined, representation of an OoS interference signal.

The first node 121 is configured to perform the obtaining of Action 401, e.g. by means of a processing circuitry 1101 within the first node 121, configured to obtain at least the first indication

$${Z}_{l - 1} , {\sum }_{i = 1}^{1 - 1} {Z}_{i}^{H} {Z}_{i} , {\text{?}}_{( l - 1 )}$$

of the interference signal s from the second node 122 configured to operate in the communications network 100 and configured to be comprised in the set of nodes 120. The interference signal s is configured to originate from the one or more interfering devices 140 outside of the communications network 100.

The first node 121 is configured to perform the obtaining of Action 402, e.g. by means of the processing circuitry 1101 within the first node 121, configured to obtain the second indication

$${Z}_{l} , {\text{?}}_{l}^{o}$$

of the interference signal s from the uplink measurements configured to be performed by the first node 121.

The first node 121 is configured to perform the determining in Action 403, e.g. by means of the processing circuitry 1101, configured to determine the third indication

$${Z}_{1} , {Z}_{l}^{H} {Z}_{l} , {\sum }_{l = 1}^{L} {Z}_{l}^{H} {Z}_{l} ,$$

of the interference signal s as the combination of the obtained first indication Zₗ₋₁,

$${\sum }_{i = 1}^{l - 1} {Z}_{l}^{H} {Z}_{i} , {\text{?}}_{( l - 1 )}$$

and the obtained second indication

$${Z}_{l} , {\text{?}}_{l}^{o} .$$

The first node 121 is configured to perform the sending in Action 404, e.g. by means of the processing circuitry 1101 within the first node 121, configured to send the third indication

$${Z}_{l} , {Z}_{l}^{H} {Z}_{l} , {\sum }_{l = 1}^{L} {Z}_{l}^{H} {Z}_{l} , {\text{?}}_{l}$$

to the third node 123 configured to operate in the communications network 100 and configured to be comprised in the set of nodes 120 or to the first network node 111 configured to operate in the communications network 100 and configured to have a connection to the set of nodes 120.

The first node 121 may be configured to perform the obtaining of Action 405, e.g. by means of the processing circuitry 1101 within the first node 121, configured to obtain, directly or indirectly, from the first network node 111, the fourth indication [symbol] ₗ of the interference signal. The fourth indication [symbol] ₗ may be configured to be based on the estimation of the interference signal by the first network node 111 based on at least the third indication

$${Z}_{l} , {Z}_{l}^{H} {Z}_{l} , {\sum }_{l = 1}^{L} {Z}_{l}^{H} {Z}_{l} , {\text{?}}_{l}$$

configured to be sent by the first node 121.

The first node 121 may be configured to perform the estimating of Action 406, e.g. by means of the processing circuitry 1101 within the first node 121, configured to estimate the first radio channel ĝₗ between the first node 121 and the one or more interfering devices 140.

The first node 121 may be configured to perform the detecting of Action 407, e.g. by means of the processing circuitry 1101 within the first node 121, configured to detect the one or more uplink signals from one or more devices 130 configured to operate in the communications network 100, using the estimated first radio channel ĝₗ and the fourth indication of the interference signal s̅ₗ to perform suppression of interference.

In some embodiments, the obtaining of the second indication may be configured to be performed by subtracting from the uplink measurements configured to be performed by the first node 121 the estimate of a received signal in the uplink measurements corresponding to only contributions from transmissions of known pilot sequences and noise.

In some embodiments, the pilot sequences may be configured to be normalized such that all of them satisfy ∥Φₖ∥²=1.

In some embodiments, the determining of the third indication s̅ₗ of the interference signal s may be configured to be performed by sequential averaging and phase rotation according to the following formula:

$${\text{?}}_{l} = 0.5 ( {\text{?}}_{( l - 1 )} + {\text{?}}_{l}^{o} {e}^{{j α}_{l}} ) \qquad ( 8 )$$

wherein the phase rotation may be configured to be calculated based on the following formula:

$${α}_{l} = - arg ( {\text{?}}_{( l - 1 )}^{H} {\text{?}}_{l}^{o} ) ,$$

in order to “align” [symbol] ₍ₗ₋₁₎ with

$${\text{?}}_{l}^{o} . where {\text{?}}_{l}^{o}$$

may be configured to be the right singular vector of ZₗΨ computed at any of nodes in the set of nodes 120,
Ψ may be configured to be the decomposition of matrix P=I−ΦΦ^{H}, such that P=ΨΨ^{H}, where Ψ may be configured to be the tall matrix that may satisfy Ψ^{H}Ψ=I,
P=I−ΦΦ^{H} may be configured to be the orthogonal projection matrix of the pilot matrix Φ,
e^{jα}^{ₗ} may be configured to be Euler's number e to the power of jαₗ, and
j may be configured to be the imaginary unit (\sqrt{−1}).

In some embodiments, the obtaining of the second indication may be configured to comprise applying a data compression algorithm.

In some embodiments, the data compression algorithm may be configured to comprise the singular value decomposition in which only the leading singular vector component may be configured to be kept.

The embodiments herein in the first node 121 may be implemented through one or more processors, such as a processing circuitry 1101 in the first node 121 depicted in FIG. 11, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 121. One such carrier may be in the form of a CD ROM disc. It is however feasible with other data carriers such as a memory stick. The computer program code may furthermore be provided as pure program code on a server and downloaded to the first node 121.

The processing circuitry 1101 may be configured to, or operable to, perform the method actions according to FIG. 4 and/or FIGS. 7-10.

The first node 121 may further comprise a memory 1102 comprising one or more memory units. The memory 1102 is arranged to be used to store obtained information, store data, configurations, schedulings, and applications etc. to perform the methods herein when being executed in the first node 121.

In some embodiments, the first node 121 may receive information from, e.g., the first network node 111, the second node 112, the third node 123, the other nodes in the set of nodes 120, the one or more devices 130 and/or another structure in the wireless communications network 100, through a receiving port 1103. In some embodiments, the receiving port 1103 may be, for example, connected to one or more antennas in first node 121.

In other embodiments, the first node 121 may receive information from another structure in the wireless communications network 100 through the receiving port 1103. Since the receiving port 1103 may be in communication with the processing circuitry 1101, the receiving port 1103 may then send the received information to the processing circuitry 1101. The receiving port 1103 may also be configured to receive other information.

The processing circuitry 1101 in the first node 121 may be further configured to transmit or send information to e.g., the first network node 111, the second node 112, the third node 123, the other nodes in the set of nodes 120, the one or more devices 130 and/or another structure in the wireless communications network 100, through a sending port 1104, which may be in communication with the processing circuitry 1101, and the memory 1102.

Those skilled in the art will also appreciate that the processing circuitry 1101 described above may comprise a combination of analog and digital modules, and/or one or more processors configured with software and/or firmware, e.g., stored in memory, that, when executed by the one or more processors such as the processing circuitry 1101, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the first node 121 may be configured to perform the actions of FIG. 4 and/or FIGS. 7-10 with respective units that may be implemented as one or more applications running on one or more processors such as the processing circuitry 1101.

Thus, the methods according to the embodiments described herein for the first node 121 may be respectively implemented by means of a computer program 1105 product, comprising instructions, i.e., software code portions, which, when executed on at least one processing circuitry 1101, cause the at least one processing circuitry 1101 to carry out the actions described herein, as performed by the first node 121. The computer program 1105 product may be stored on a computer-readable storage medium 1106. The computer-readable storage medium 1106, having stored thereon the computer program 1105, may comprise instructions which, when executed on at least one processing circuitry 1101, cause the at least one processing circuitry 1101 to carry out the actions described herein, as performed by the first node 121. In some embodiments, the computer-readable storage medium 1106 may be a non-transitory computer-readable storage medium, such as a CD ROM disc, or a memory stick. In other embodiments, the computer program 1105 product may be stored on a carrier containing the computer program 1105 just described, wherein the carrier is one of an electronic signal, optical signal, radio signal, or the computer-readable storage medium 1106, as described above.

The first node 121 may comprise a communication interface configured to facilitate communications between the first node 121 and other nodes or devices, e.g., the first network node 111, the second node 112, the third node 123, the other nodes in the set of nodes 120, the one or more devices 130 and/or another structure in the wireless communications network 100. The interface may, for example, include a transceiver configured to transmit and receive radio signals over an air interface in accordance with a suitable standard.

In other embodiments, the first node 121 may also comprise a radio circuitry 1107, which may comprise e.g., the receiving port 1103 and the sending port 1104. The radio circuitry 1107 may be configured to set up and maintain at least a wireless connection with the first network node 111, the second node 112, the third node 123, the other nodes in the set of nodes 120, the one or more devices 130 and/or another structure in the wireless communications network 100. Circuitry may be understood herein as a hardware component.

Hence, embodiments herein also relate to the first node 121 comprising the processing circuitry 1101 and the memory 1102, said memory 1102 containing instructions executable by said processing circuitry 1101, whereby the first node 121 is operative to perform the actions described herein in relation to the first node 121, e.g., in FIG. 4 and/or FIGS. 7-10.

FIG. 12 depicts an example of the arrangement that the first network node 111 may comprise to perform the method actions described above in relation to FIG. 5 and/or FIGS. 7-10. The first network node 111 may be understood to be for handling the interference signal s. The first network node 111 is configured to operate in the communications network 100. The communications network 100 is configured to comprise the set of nodes 120 configured to provide the segmented front-haul.

In some embodiments, at least one of the following may apply: a) each of the nodes in the set of nodes 120 may be configured to be an AP, b) each of the nodes in the set of nodes 120 may be configured to have the respective plurality of antennas M, c) the communications network 100 may be configured to be a d-MIMO, network, d) the first network node 111 may be configured to be a CPU d-MIMO network, e) the set of nodes 120 may be configured to be arranged with a stripe topology, f) the set of nodes 120 may be configured to be arranged with a radioweave topology, and g) the set of nodes 120 may be configured to be arranged with a stripe topology, wherein the first node 121 and the second node 122 may be configured to be immediately adjacent.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first network node 111 and will thus not be repeated here. For example, the third indication may be configured to be a third, combined, representation of an OoS interference signal.

The first network node 111 is configured to perform the obtaining in this Action 501, e.g. by means of a processing circuitry 1201 within the first network node 111, configured to obtain the third indication

$${Z}_{l} , {Z}_{l}^{H} {Z}_{l} , {\sum }_{l = 1}^{L} {Z}_{l}^{H} {Z}_{l} , {\text{?}}_{l}$$

from the first node 121 configured to be comprised in the set of nodes 120. The third indication is configured to be of the interference signal s. The interference signal s is configured to originate from the one or more interfering devices 140 outside of the communications network 100. The third indication is configured to be of the interference signal s as a combination of at least the first indication

$${Z}_{l - 1} , {\sum }_{i = 1}^{l - 1} {Z}_{i}^{H} {Z}_{i} , {\text{?}}_{( l - 1 )}$$

of the interference signal s from the second node 122 configured to operate in the communications network 100 and configured to be comprised in the set of nodes 120, and the second indication

$${Z}_{l} , {\text{?}}_{l}^{o}$$

of the interference signal s, as configured to be obtained by the first node 121 from uplink measurements configured to be performed by the first node 121.

The first network node 111 is configured to perform the determining in this Action 502, e.g. by means of the processing circuitry 1201 within the first network node 111, configured to determine the fourth indication [symbol] ₗ of the interference signal. The fourth indication [symbol] ₗ is configured to be based on the estimation of the interference signal by the first network node 111 configured to be based on at least the third indication

$${Z}_{l} , {Z}_{l}^{H} {Z}_{l} , {\sum }_{l = 1}^{L} {Z}_{l}^{H} {Z}_{l} , {\text{?}}_{l}$$

configured to be obtained from the first node 121.

The first network node 111 is configured to perform the sending in this Action 503, e.g., by means of the processing circuitry 1201, configured to send, directly or indirectly, the fourth indication to the first node 121.

In some embodiments, the determining of the fourth indication [symbol] ₗ may be configured to be performed by first dispreading the interference signal according to the following formula:

$$\begin{matrix}{Z}_{l} Ψ = ( {g}_{l} {s}^{H} + {N}_{l} ) Ψ \\ = {g}_{l} {\overline{s}}^{H} + {N}_{l}^{′}\end{matrix} \qquad ( 4 )$$

where:
   ZₗΨ may be configured to be the dominant right singular vector,
   gₗ may be configured to be the first radio channel ĝₗ between the first node 121 and the one or more interfering devices 140,
   s^{H} may be configured to be the Hermitian transpose of s,
   N′ₗ=NₗΨ may be configured to be an M×τₚ−K noise matrix,
   K may be configured to be mutually orthogonal pilot sequences of length τₚ, configured to be transmitted by the one or more devices 130 configured to operate in the communications network (100), wherein τₚ≥K,
   Ψ may be configured to be the decomposition of the matrix P=I−ΦΦ^{H}, such that P=ΨΨ^{H}, where Ψ may be understood to be the tall matrix that may satisfy Ψ^{H}Ψ=I, and
   P=I−ΦΦ^{H} may be configured to be the orthogonal projection matrix of the pilot matrix Φ.

In some embodiments, the determining of the fourth indication s̅ₗ may be configured to be performed by solving a least squares problem according to the following formula:

$${minimize}_{g , \overline{s}} ‖ Z Ψ - g {\overline{s}}^{H} {‖}_{F} \qquad ( 5 )$$

where:
   g may be configured to be the first radio channel between the set of nodes 120 and the one or more interfering devices 140,
   s̅ may be configured to be the estimate the interference signal,
   ZₗΨ may be configured to be the dominant right singular vector,
   s̅^{H} may be configured to be the estimate the interference signal in the second radio channel between the set of nodes 120 and the one or more devices 130 configured to operate in the communications network 100,

$$Z = {[ {Z}_{1}^{T} … {Z}_{L}^{T} ]}^{T} ,$$

$$g = {[ {g}_{1}^{T} … {g}_{L}^{T} ]}^{T} ,$$

T may be configured to be the transpose operator,
F may be configured to be the Frobenius norm,
Ψ may be configured to be the decomposition of matrix P=I−ΦΦ^{H}, such that P=ΦΦ^{H}, where Ψ may be configured to be the tall matrix that may satisfy Ψ^{H}Ψ=I
P=I−ΦΦ^{H} may be configured to be the orthogonal projection matrix of the pilot matrix Φ, and
   the solution may be configured to be given by the best rank-1 approximation of ZΨ, and the estimate of s may be configured to be given by the dominant eigenvector of Ψ^{H}Z^{H}ZΨ.

In some embodiments, the second indication may be configured to be obtained by subtracting from the uplink measurements configured to be performed by the first node 121 an estimate of the received signal in the uplink measurements corresponding to only contributions from transmissions of known pilot sequences and noise.

In some embodiments, the pilot sequences may be configured to be normalized such that all of them satisfy ∥Φₖ∥²=1.

In some embodiments, the third indication s̅ₗ of the interference signal s may be configured to be determined by sequential averaging and phase rotation according to the following formula:

$${\text{?}}_{1} = 0 \text{.5} ( {\text{?}}_{( l - 1 )} + {\text{?}}_{l}^{o} {e}^{j {α}_{1}} ) \qquad ( 8 )$$

wherein the phase rotation may be configured to be calculated based on the following formula:

$${α}_{1} = - arg ( {\text{?}}_{( l - 1 )}^{H} {\text{?}}_{l}^{o} ) ,$$

in order to “align”

$${\text{?}}_{( l - 1 )} with {\text{?}}_{l}^{o} .$$

$$where :$$

$${\text{?}}_{l}^{o}$$

may be configured to be the right singular vector of ZₗΨ computed at any of nodes in the set of nodes 120,
Ψ may be configured to be the decomposition of matrix P=I−ΦΦ^{H}, such that P=ΨΨ^{H}, where Ψ may be the tall matrix that may satisfy Ψ^{H}Ψ=I,
P=I−ΦΦ^{H} may be configured to be the orthogonal projection matrix of the pilot matrix Φ,
e^{jα}^{ₗ} may be configured to be Euler's number e to the power of jαₗ, and
j may be configured to be the imaginary unit (\sqrt{−1}).

In some embodiments, the data compression algorithm may be configured to have been applied to the second indication.

In some embodiments, the data compression algorithm may be configured to comprise the singular value decomposition in which only the leading singular vector component may be configured to be kept.

The embodiments herein in the first network node 111 may be implemented through one or more processors, such as a processing circuitry 1201 in the first network node 111 depicted in FIG. 12, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first network node 111. One such carrier may be in the form of a CD ROM disc. It is however feasible with other data carriers such as a memory stick. The computer program code may furthermore be provided as pure program code on a server and downloaded to the first network node 111.

The processing circuitry 1201 may be configured to, or operable to, perform the method actions according to FIG. 5 and/or FIGS. 7-10.

The first network node 111 may further comprise a memory 1202 comprising one or more memory units. The memory 1202 is arranged to be used to store obtained information, store data, configurations, schedulings, and applications etc. to perform the methods herein when being executed in the first network node 111.

In some embodiments, the first network node 111 may receive information from, e.g., the first node 121, the second node 112, the third node 123, the other nodes in the set of nodes 120, the one or more devices 130 and/or another structure in the wireless communications network 100, through a receiving port 1203. In some embodiments, the receiving port 1203 may be, for example, connected to one or more antennas in first network node 111. In other embodiments, the first network node 111 may receive information from another structure in the wireless communications network 100 through the receiving port 1203. Since the receiving port 1203 may be in communication with the processing circuitry 1201, the receiving port 1203 may then send the received information to the processing circuitry 1201. The receiving port 1203 may also be configured to receive other information.

The processing circuitry 1201 in the first network node 111 may be further configured to transmit or send information to e.g., the first node 121, the second node 112, the third node 123, the other nodes in the set of nodes 120, the one or more devices 130 and/or another structure in the wireless communications network 100, through a sending port 1204, which may be in communication with the processing circuitry 1201, and the memory 1202.

Those skilled in the art will also appreciate that the processing circuitry 1201 described above may comprise a combination of analog and digital modules, and/or one or more processors configured with software and/or firmware, e.g., stored in memory, that, when executed by the one or more processors such as the processing circuitry 1201, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the first network node 111 may be configured to perform the actions of FIG. 5 and/or FIGS. 7-10 with respective units that may be implemented as one or more applications running on one or more processors such as the processing circuitry 1201.

Thus, the methods according to the embodiments described herein for the first network node 111 may be respectively implemented by means of a computer program 1205 product, comprising instructions, i.e., software code portions, which, when executed on at least one processing circuitry 1201, cause the at least one processing circuitry 1201 to carry out the actions described herein, as performed by the first network node 111. The computer program 1205 product may be stored on a computer-readable storage medium 1206. The computer-readable storage medium 1206, having stored thereon the computer program 1205, may comprise instructions which, when executed on at least one processing circuitry 1201, cause the at least one processing circuitry 1201 to carry out the actions described herein, as performed by the first network node 111. In some embodiments, the computer-readable storage medium 1206 may be a non-transitory computer-readable storage medium, such as a CD ROM disc, or a memory stick. In other embodiments, the computer program 1205 product may be stored on a carrier containing the computer program 1205 just described, wherein the carrier is one of an electronic signal, optical signal, radio signal, or the computer-readable storage medium 1206, as described above.

The first network node 111 may comprise a communication interface configured to facilitate communications between the first network node 111 and other nodes or devices, e.g., the first node 121, the second node 112, the third node 123, the other nodes in the set of nodes 120, the one or more devices 130 and/or another structure in the wireless communications network 100. The interface may, for example, include a transceiver configured to transmit and receive radio signals over an air interface in accordance with a suitable standard.

In other embodiments, the first network node 111 may also comprise a radio circuitry 1207, which may comprise e.g., the receiving port 1203 and the sending port 1204. The radio circuitry 1207 may be configured to set up and maintain at least a wireless connection with the first node 121, the second node 112, the third node 123, the other nodes in the set of nodes 120, the one or more devices 130 and/or another structure in the wireless communications network 100. Circuitry may be understood herein as a hardware component.

Hence, embodiments herein also relate to the first network node 111 comprising the processing circuitry 1201 and the memory 1202, said memory 1202 containing instructions executable by said processing circuitry 1201, whereby the first network node 111 is operative to perform the actions described herein in relation to the first network node 111, e.g., in FIG. and/or FIGS. 7-10.

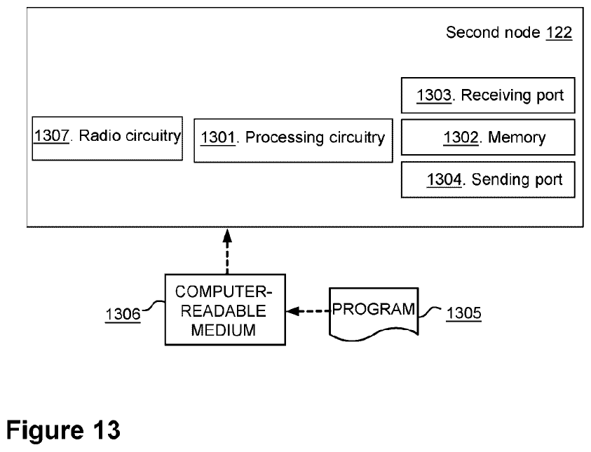

FIG. 13 depicts an example of the arrangement that the second node 122 may comprise to perform the method actions described above in relation to FIG. 6 and/or FIGS. 7-10. The second node 122 may be understood to be for handling the interference signal s. The second node 122 is configured to operate in the communications network 100. The second node 122 is configured to be comprised in the set of nodes 120 configured to provide the segmented front-haul.

In some embodiments, at least one of the following may apply: a) each of the nodes in the set of nodes 120 may be configured to be an AP, b) each of the nodes in the set of nodes 120 may be configured to have the respective plurality of antennas M, c) the communications network 100 may be configured to be a d-MIMO, network, d) the first network node 111 may be configured to be a CPU d-MIMO network, e) the set of nodes 120 may be configured to be arranged with a stripe topology, f) the set of nodes 120 may be configured to be arranged with a radioweave topology, and g) the set of nodes 120 may be configured to be arranged with a stripe topology, wherein the first node 121 and the second node 122 may be configured to be immediately adjacent.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second node 122 and will thus not be repeated here. For example, the third indication may be configured to be a third, combined, representation of an OoS interference signal.

The second node 122 is configured to perform the obtaining of Action 601, e.g. by means of a processing circuitry 1301 within the second node 122, configured to obtain the first indication

$${Z}_{l} , {\text{?}}_{l}^{o}$$

of the interference signal s from uplink measurements configured to be performed by the second node 122. The interference signal s is configured to originate from the one or more interfering devices 140 outside of the communications network 100.

The second node 122 is also configured to perform the sending of Action 602, e.g. by means of the processing circuitry 1301 within the second node 122, configured to send the first indication

$${Z}_{l} , {\text{?}}_{l}^{0}$$

to the first node 121 configured to operate in the communications network 100 and configured to be comprised in the set of nodes 120.

The second node 122 may be configured to perform the obtaining of Action 603, e.g. by means of the processing circuitry 1301 within the second node 122, configured to obtain directly or indirectly, from the first network node 111, the fourth indication [symbol] of the interference signal. The fourth indication [symbol] ₗ may be configured to be based on the estimation of the interference signal by the first network node 111 based on at least the first indication

$${Z}_{l} , {\text{?}}_{l}^{0}$$

configured to be sent by the second node 122.

The second node 122 may be configured to perform the estimating of Action 604, e.g. by means of the processing circuitry 1301 within the second node 122, configured to estimate the third radio channel ĝₗ between the second node 122 and the one or more interfering devices 140.

The second node 122 may be configured to perform the detecting of Action 605, e.g. by means of the processing circuitry 1301 within the second node 122, configured to detect the one or more uplink signals from the one or more devices 130 configured to operate in the communications network 100, using the estimated third radio channel ĝₗ and the fourth indication of the interference signal [symbol] ₗ to perform suppression of interference.

In some embodiments, the obtained fourth indication [symbol] ₗ of the interference signal may be configured to be further based on the third indication

$${Z}_{l} , {Z}_{l}^{H} {Z}_{l} , {\sum }_{l = 1}^{L} {Z}_{l}^{H} {Z}_{l} , {\text{?}}_{l}$$

of the interference signal s, configured to be determined by the first node 121 as the combination of the sent first indication

$${Z}_{l - 1} , {\sum }_{i = 1}^{l - 1} {Z}_{i}^{H} {Z}_{l} , {\text{?}}_{( l - 1 )}$$

and the second indication

$${Z}_{l} , {\text{?}}_{l}^{o}$$

of the interference signal s, configured to be obtained by the first node 121 from the uplink measurements configured to be performed by the first node 121. The third indication [symbol] ₗ of the interference signal s may be configured to have been determined by sequential averaging and phase rotation according to the following formula:

$${\text{?}}_{l} = = 0 \text{.5} ( {\text{?}}_{( l - 1 )} + {\text{?}}_{l}^{o} {e}^{j {α}_{l}} )$$

wherein the phase rotation is may be configured to be calculated based on the following formula:

$${α}_{l} = - arg ( {\text{?}}_{( l - 1 )}^{H} {\text{?}}_{l}^{0} ) , in order to “ align ” {\text{?}}_{( l - 1 )} with {\text{?}}_{l}^{0} .$$

$$where :$$

$${\text{?}}_{l}^{0}$$

may be configured to be the right singular vector of ZₗΨ computed at any of nodes in the set of nodes 120,
Ψ may be configured to be the decomposition of matrix P=I−ΦΦ^{H}, such that P=ΨΨ^{H}, where Ψ may be the tall matrix that may satisfy Ψ^{H}Ψ=I
P=I−ΦΦ^{H} may be configured to be the orthogonal projection matrix of the pilot matrix Φ,
e^{jα}^{ₗ} may be configured to be Euler's number e to the power of jαₗ, and
j may be configured to be the imaginary unit (\sqrt{−1}).

In some embodiments, the obtaining of the first indication may be configured to be performed by subtracting from the uplink measurements configured to be performed by the second node 122 the estimate of the received signal in the uplink measurements corresponding to only contributions from transmissions of known pilot sequences and noise.

In some embodiments, the pilot sequences may be configured to be normalized such that all of them satisfy ∥Φₖ∥²=1.

In some embodiments, the obtaining of the first indication may be configured to comprise applying the data compression algorithm.

In some embodiments, the data compression algorithm may be configured to comprise the singular value decomposition in which only the leading singular vector component may be configured to be kept.

The embodiments herein in the second node 122 may be implemented through one or more processors, such as a processing circuitry 1301 in the second node 122 depicted in FIG. 13, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 122. One such carrier may be in the form of a CD ROM disc. It is however feasible with other data carriers such as a memory stick. The computer program code may furthermore be provided as pure program code on a server and downloaded to the second node 122.

The processing circuitry 1301 may be configured to, or operable to, perform the method actions according to FIG. 6 and/or FIGS. 7-10.

The second node 122 may further comprise a memory 1302 comprising one or more memory units. The memory 1302 is arranged to be used to store obtained information, store data, configurations, schedulings, and applications etc. to perform the methods herein when being executed in the second node 122.

In some embodiments, the second node 122 may receive information from, e.g., the first network node 111, the first node 121, the third node 123, the other nodes in the set of nodes 120, the one or more devices 130 and/or another structure in the wireless communications network 100, through a receiving port 1303. In some embodiments, the receiving port 1303 may be, for example, connected to one or more antennas in second node 122. In other embodiments, the second node 122 may receive information from another structure in the wireless communications network 100 through the receiving port 1303. Since the receiving port 1303 may be in communication with the processing circuitry 1301, the receiving port 1303 may then send the received information to the processing circuitry 1301. The receiving port 1303 may also be configured to receive other information.

The processing circuitry 1301 in the second node 122 may be further configured to transmit or send information to e.g., the first network node 111, the first node 121, the third node 123, the other nodes in the set of nodes 120, the one or more devices 130 and/or another structure in the wireless communications network 100, through a sending port 1304, which may be in communication with the processing circuitry 1301, and the memory 1302.

Those skilled in the art will also appreciate that the processing circuitry 1301 described above may comprise a combination of analog and digital modules, and/or one or more processors configured with software and/or firmware, e.g., stored in memory, that, when executed by the one or more processors such as the processing circuitry 1301, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the second node 122 may be configured to perform the actions of FIG. 6 and/or FIGS. 7-10 with respective units that may be implemented as one or more applications running on one or more processors such as the processing circuitry 1301.

Thus, the methods according to the embodiments described herein for the second node 122 may be respectively implemented by means of a computer program 1305 product, comprising instructions, i.e., software code portions, which, when executed on at least one processing circuitry 1301, cause the at least one processing circuitry 1301 to carry out the actions described herein, as performed by the second node 122. The computer program 1305 product may be stored on a computer-readable storage medium 1306. The computer-readable storage medium 1306, having stored thereon the computer program 1305, may comprise instructions which, when executed on at least one processing circuitry 1301, cause the at least one processing circuitry 1301 to carry out the actions described herein, as performed by the second node 122. In some embodiments, the computer-readable storage medium 1306 may be a non-transitory computer-readable storage medium, such as a CD ROM disc, or a memory stick. In other embodiments, the computer program 1305 product may be stored on a carrier containing the computer program 1305 just described, wherein the carrier is one of an electronic signal, optical signal, radio signal, or the computer-readable storage medium 1306, as described above.

The second node 122 may comprise a communication interface configured to facilitate communications between the second node 122 and other nodes or devices, e.g., the first network node 111, the first node 121, the third node 123, the other nodes in the set of nodes 120, the one or more devices 130 and/or another structure in the wireless communications network 100. The interface may, for example, include a transceiver configured to transmit and receive radio signals over an air interface in accordance with a suitable standard.

In other embodiments, the second node 122 may also comprise a radio circuitry 1307, which may comprise e.g., the receiving port 1303 and the sending port 1304. The radio circuitry 1307 may be configured to set up and maintain at least a wireless connection with the first network node 111, the first node 121, the third node 123, the other nodes in the set of nodes 120, the one or more devices interfering 130 and/or another structure in the wireless communications network 100. Circuitry may be understood herein as a hardware component.

Hence, embodiments herein also relate to the second node 122 comprising the processing circuitry 1301 and the memory 1302, said memory 1302 containing instructions executable by said processing circuitry 1301, whereby the second node 122 is operative to perform the actions described herein in relation to the second node 122, e.g., in FIG. 6 and/or FIGS. 7-10.

Embodiments herein may also comprise the communications network 100, comprising the first node 121 configured as described in relation to FIG. 11, the first network node 111 configured as described in relation to FIG. 12, and the second node 122 configured as described in relation to FIG. 13.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### Examples Related to Embodiments Herein

In examples related to embodiments herein, any of the actions depicted in any of FIGS. 4-6 may be considered optional. Particular examples related to embodiments herein may be as follows.

Example 1. A method performed by a first node (121), the method being for handling an interference signal (s), the first node (121) operating in a communications network (100) and being comprised in a set of nodes (120) providing a segmented front-haul, the method comprising:
obtaining (401) at least a first indication

$$( {Z}_{l - 1} , {\sum }_{i = 1}^{l - 1} {Z}_{i}^{H} {Z}_{i} , {\text{?}}_{( l - 1 )} )$$

of an interference signal (s) from a second node (122) operating in the communications network (100) and comprised in the set of nodes (120), wherein the interference signal (s) originates from one or more interfering devices (140) outside of the communications network (100),
obtaining (402) a second indication

$$( {Z}_{l} , {\text{?}}_{l}^{o} )$$

of the interference signal (s) from uplink measurements performed by the first node (121),
determining (403) a third indication

$$( {Z}_{l} , {Z}_{l}^{H} {Z}_{l} , {\sum }_{1 = 1}^{L} {Z}_{l}^{H} {Z}_{l} , {\text{?}}_{l} )$$

of the interference signal (s) as a combination of the obtained first indication

$$( {Z}_{l - 1} , {\sum }_{i = 1}^{l - 1} {Z}_{i}^{H} {Z}_{i} , \text{?} ( l - 1 ) ) .$$

and the obtained second indication

$$( {Z}_{l} , {\text{?}}_{l}^{o} ) ,$$

and
sending (404) the third indication

$$( {Z}_{l} , {Z}_{l}^{H} {Z}_{l} , {\sum }_{l = 1}^{L} {Z}_{l}^{H} {Z}_{l} , {\text{?}}_{l} )$$

to a third node (123) operating in the communications network (100) and comprised in the set of nodes (120) or to a first network node (111) operating in the communications network (100) and having a connection to the set of nodes (120).

Example 2. The method according to example 1, further comprising at least one of:
obtaining (405), directly or indirectly, from the first network node (111), a fourth indication ( [symbol] ₗ) of the interference signal, the fourth indication ( [symbol] ₗ) being based on an estimation of the interference signal by the first network node (111) based on at least the third indication

$$( {Z}_{l} , {Z}_{l}^{H} {Z}_{l} , {\sum }_{l = 1}^{L} {Z}_{l}^{H} {Z}_{l} , {\text{?}}_{l} )$$

sent by the first node (121),
estimating (406) a first radio channel (ĝₗ) between the first node (121) and the one or more interfering devices (140), and
detecting (407) one or more uplink signals from one or more devices (130) operating in the communications network (100), using the estimated first radio channel (ĝₗ) and the fourth indication of the interference signal ( [symbol] ₗ) to perform suppression of interference.

Example 3. The method according to any of examples 1-2, wherein the obtaining (402) of the second indication is performed according to the following formula:

$$\begin{matrix}{Z}_{l} = {Y}_{l} - \sqrt{p {τ}_{p}} {\hat{H}}_{l} {Φ}^{H} \\ = ( {g}_{l} {s}^{H} + {N}_{l} ) ( I - {ΦΦ}^{H} ) \\ = ( {g}_{l} {s}^{H} + {N}_{l} ) P\end{matrix} \qquad ( 3 )$$

where:

Yₗ=\sqrt{pτₚ}HₗΦ^{H}+gₗs^{H}+Nₗ (1)
where:

$$\begin{matrix}{\hat{H}}_{l} = \frac{1}{\sqrt{p {τ}_{p}}} {Y}_{l} Φ \\ = {H}_{l} + \frac{1}{\sqrt{p {τ}_{p}}} ( {g}_{l} {s}^{H} + {N}_{l} ) Φ\end{matrix} \qquad ( 2 )$$

and where:
K are mutually orthogonal pilot sequences of length τₚ, transmitted by one or more devices (130) operating in the communications network (100), wherein τₚ≥K, wherein one such pilot sequence is assigned to each of the K one or more devices (130),
P=I−ΦΦ^{H} is an orthogonal projection matrix of a pilot matrix (Φ),
Φ=[φ₁ . . . φ_{K}] is a matrix comprising all pilot sequences,
p is transmit power, normalized,
pτₚ is a normalized signal to interference noise ratio,
gₗ is a first radio channel (ĝₗ) between the first node (121) and one or more interfering devices (140),
s is the interference signal,
Hₗ is an estimation by the first node (121) of a second radio channel between the first node (121) and the one or more devices (130), and
Nₗ indicates receiver noise at the first node (121).

Example 4. The method according to example 3, wherein the pilots sequences are normalized such that all of them satisfy ∥φₖ∥²=1.

Example 5. The method according to any of examples 1-4, wherein the determining (403) of the third indication ( [symbol] ₗ) of the interference signal (s) is performed by sequential averaging and phase rotation according to the following formula:

$${\text{?}}_{l} = 0.5 ( {\text{?}}_{( l - 1 )} + {\text{?}}_{l}^{o} {e}^{j {α}_{l}} ) \qquad ( 8 )$$

wherein the phase rotation is calculated based on the following formula:

$${α}_{l} = - arg ( {\text{?}}_{( l - 1 )}^{H} {\text{?}}_{l}^{o} ) ,$$

in order to “align”

$${\text{?}}_{( l - 1 )} with {\text{?}}_{l}^{o} .$$

Example 6. The method according to any of examples 1-5, wherein the obtaining (402) of the second indication comprises applying a data compression algorithm.

Example 7. The method according to any of examples 1-6, wherein at least one of:
a) each of the nodes in the set of nodes (120) is an Access Point, AP,
b) each of the nodes in the set of nodes (120) has a respective plurality of antennas (M),
c) the communications network (100) is a distributed Multiple Input Multiple Output, d-MIMO, network,
d) the first network node (111) is a central processing unit, CPU, of the d-MIMO network,
e) the set of nodes (120) are arranged with a stripe topology, and
f) the set of nodes (120) are arranged with a stripe topology, wherein the first node (121) and the second node (122) are immediately adjacent.

Example 8. A method performed by a first network node (111), the method being for handling an interference signal (s), the first network node (111) operating in a communications network (100) comprising a set of nodes (120) providing a segmented front-haul, the method comprising:
obtaining (501) a third indication

$$( {Z}_{l} , {Z}_{l}^{H} {Z}_{l} , {\sum }_{l = 1}^{L} {Z}_{l}^{H} {Z}_{l} , {\text{?}}_{l} )$$

from a first node (121) comprised in the set of nodes (120) the third indication being of an interference signal (s), wherein the interference signal (s) originates from one or more interfering devices (140) outside of the communications network (100), and wherein the third indication is of the interference signal (s) as a combination of at least a first indication

$$( {Z}_{l - 1} , {\sum }_{i = 1}^{l - 1} {Z}_{i}^{H} {Z}_{i} , {\text{?}}_{( l - 1 )} )$$

of the interference signal (s) from a second node (122) operating in the communications network 100) and comprised in the set of nodes (120), and a second indication

$$( {Z}_{l} , {\text{?}}_{l}^{o} )$$

of the interference signal (s), as obtained by the first node (121) from uplink measurements performed by the first node (121),
determining (502) a fourth indication ( [symbol] ₗ) of the interference signal, the fourth indication ( [symbol] ₗ) being based on an estimation of the interference signal by the first network node (111) based on at least the third indication

$$( {Z}_{l} , {Z}_{l}^{H} {Z}_{l} , {\sum }_{l = 1}^{L} {Z}_{l}^{H} {Z}_{l} , {\text{?}}_{l} )$$

obtained from the first node (121), and
sending (503), directly or indirectly, the fourth indication to the first node (121).

Example 9. The method according to example 8, wherein the determining (502) of the fourth indication ( [symbol] ₗ) is performed by first dispreading the interference signal according to the following formula:

$$\begin{matrix}{Z}_{l} Ψ = ( {g}_{l} {s}^{H} + {N}_{l} ) Ψ \\ = {g}_{l} {\overline{s}}^{H} + {N}_{l}^{′}\end{matrix} \qquad ( 4 )$$

where N′ₗ=NₗΨ is an M×τₚ−K noise matrix.

Example 10. The method according to any of examples 8-9, wherein the determining (502) of the fourth indication ( [symbol] ₗ) is performed by solving a least squares problem according to the following formula:

$${minimize}_{g , \overline{s}} {‖ Z Ψ - g {\overline{s}}^{H} ‖}_{F} \qquad ( 5 )$$

$$where Z = {[ {Z}_{1}^{T} … {Z}_{L}^{T} ]}^{T} , and g = {[ {g}_{1}^{T} … {g}_{L}^{T} ]}^{T}$$

and the solution is given by the best rank-1 approximation of ZΨ, and the estimate of s̅ is given by the dominant eigenvector of Ψ^{H}Z^{H}ZΨ.

Example 11. The method according to any of examples 8-10, wherein the second indication is obtained according to the following formula:

$$\begin{matrix}{Z}_{l} = {Y}_{l} - \sqrt{p {τ}_{p}} {\hat{H}}_{l} {Φ}^{H} \\ = ( {g}_{l} {s}^{H} + {N}_{l} ) ( I - {ΦΦ}^{H} ) \\ = ( {g}_{l} {s}^{H} + {N}_{l} ) P\end{matrix} \qquad ( 3 )$$

where:

Yₗ=pτₚHₗΦ^{H}+gₗs^{H}+Nₗ (1)
where:

$$\begin{matrix}{\hat{H}}_{l} = \frac{1}{\sqrt{p {τ}_{p}}} {Y}_{l} Φ \\ = {H}_{l} + \frac{1}{\sqrt{p {τ}_{p}}} ( {g}_{l} {s}^{H} + {N}_{l} ) Φ\end{matrix} \qquad ( 2 )$$

and where:
K are mutually orthogonal pilot sequences of length τₚ, transmitted by one or more devices (130) operating in the communications network (100), wherein τₚ≥K, wherein one such pilot sequence is assigned to each of the K one or more devices (130),
P=I−ΦΦ^{H} is an orthogonal projection matrix of a pilot matrix (Φ),
Φ=[φₗ . . . φ_{K}] is a matrix comprising all pilot sequences,
p is transmit power, normalized,
pτₚ is a normalized signal to interference noise ratio,
gₗ is a first radio channel (ĝₗ) between the first node (121) and one or more interfering devices (140),
s is the interference signal,
Hₗ is an estimation by the first node (121) of a second radio channel between the first node (121) and the one or more devices (130), and
Nₗ indicates receiver noise at the first node (121).

Example 12. The method according to example 11, wherein the pilots sequences are normalized such that all of them satisfy ∥φₖ∥²=1.

Example 13. The method according to any of examples 8-12, wherein the third indication ( [symbol] ₗ) of the interference signal (s) is determined by sequential averaging and phase rotation according to the following formula:

$${\text{?}}_{l} = 0.5 ( {\text{?}}_{( l - 1 )} + {\text{?}}_{l}^{o} {e}^{j {α}_{l}} ) \qquad ( 8 )$$

wherein the phase rotation is calculated based on the following formula:

$${α}_{l} = - arg ( {\text{?}}_{( l - 1 )}^{H} {\text{?}}_{l}^{o} ) ,$$

in order to “align”

$${\text{?}}_{( l - 1 )} with {\text{?}}_{l}^{o} .$$

Example 14. The method according to any of examples 8-13, wherein a data compression algorithm has been applied to the second indication.

Example 15. The method according to any of examples 8-14, wherein at least one of:
a) each of the nodes in the set of nodes (120) is an Access Point, AP,
b) each of the nodes in the set of nodes (120) has a respective plurality of antennas (M),
c) the communications network (100) is a distributed Multiple Input Multiple Output, d-MIMO, network,
d) the first network node (111) is a central processing unit, CPU, of the d-MIMO network,
e) the set of nodes (120) are arranged with a stripe topology, and
f) the set of nodes (120) are arranged with a stripe topology, wherein the first node (121) and the second node (122) are immediately adjacent.

Example 16. A method performed by a second node (122), the method being for handling an interference signal (s), the second node (122) operating in a communications network (100) and being comprised in a set of nodes (120) providing a segmented front-haul, the method comprising:
obtaining (601) a first indication

$$( {Z}_{l} , {\text{?}}_{l}^{o} )$$

of an interference signal (s) from uplink measurements performed by the second node (122), wherein the interference signal (s) originates from one or more interfering devices (140) outside of the communications network (100), and
sending (602) the first indication

$$( {Z}_{l} , {\text{?}}_{l}^{o} )$$

to a first node (121) operating in the communications network (100) and comprised in the set of nodes (120).

Example 17. The method according to example 16, further comprising at least one of:
obtaining (603), directly or indirectly, from the first network node (111), a fourth indication ( [symbol] ₗ) of the interference signal, the fourth indication ( [symbol] ₗ) being based on an estimation of the interference signal by the first network node (111) based on at least the first indication

$$( {Z}_{l} , {\text{?}}_{l}^{o} )$$

sent by the second node (122),
estimating (604) a third radio channel (ĝₗ) between the second node (122) and the one or more interfering devices (140), and
detecting (605) one or more uplink signals from one or more devices (130) operating in the communications network (100), using the estimated third radio channel (ĝₗ) and the fourth indication of the interference signal ( [symbol] ₗ) to perform suppression of interference.

Example 18. The method according to example 17, wherein the obtained fourth indication ( [symbol] ₗ) of the interference signal is further based on a third indication

$$( {Z}_{l} , {Z}_{l}^{H} {Z}_{l} , {\sum }_{l = 1}^{L} {Z}_{l}^{H} {Z}_{l} , {\text{?}}_{l} )$$

of the interference signal (s), determined by the first node (121) as a combination of the sent first indication

$$( {Z}_{l - 1} , {\sum }_{i = 1}^{l - 1} {Z}_{i}^{H} {Z}_{i} , {\text{?}}_{( l - 1 )} )$$

and a second indication

$$( {Z}_{l} , {\text{?}}_{l}^{o} )$$

of the interference signal (s), obtained by the first node (121) from uplink measurements performed by the first node (121), wherein the third indication ( [symbol] ₗ) of the interference signal (s) has been determined by sequential averaging and phase rotation according to the following formula:

$${\text{?}}_{l} = 0.5 ( {\text{?}}_{( l - 1 )} + {\text{?}}_{l}^{o} {e}^{j {α}_{l}} ) \qquad ( 8 )$$

wherein the phase rotation is calculated based on the following formula:

$${α}_{l} = - arg ( {\text{?}}_{( l - 1 )}^{H} {\text{?}}_{l}^{o} ) ,$$

in order to “align”

$${\text{?}}_{( l - 1 )} with {\text{?}}_{l}^{o} .$$

Example 19. The method according to any of examples 16-18, wherein the obtaining (601) of the first indication is performed according to the following formula:

$$\begin{matrix}{Z}_{l} = {Y}_{l} - \sqrt{p {τ}_{p}} {\hat{H}}_{l} {Φ}^{H} \\ = ( {g}_{l} {s}^{H} + {N}_{l} ) ( I - {ΦΦ}^{H} ) \\ = ( {g}_{l} {s}^{H} + {N}_{l} ) P\end{matrix} \qquad ( 3 )$$

where:

Yₗ=\sqrt{pτₚ}HₗΦ^{H}+gₗs^{H}+Nₗ (1)
where:

$$\begin{matrix}{\hat{H}}_{l} = \frac{1}{\sqrt{p {τ}_{p}}} {Y}_{l} Φ \\ = {H}_{l} + \frac{1}{\sqrt{p {τ}_{p}}} ( {g}_{l} {s}^{H} + {N}_{l} ) Φ\end{matrix} \qquad ( 2 )$$

and where:
K are mutually orthogonal pilot sequences of length τₚ, transmitted by one or more devices (130) operating in the communications network (100), wherein τₚ≥K, wherein one such pilot sequence is assigned to each of the K one or more devices (130),
P=I−ΦΦ^{H} is an orthogonal projection matrix of a pilot matrix (Φ),
Φ=[φ₁ . . . φ_{K}] is a matrix comprising all pilot sequences,
p is transmit power, normalized,
pτₚ is a normalized signal to interference noise ratio,
gₗ is a third radio channel (ĝₗ) between the second node (122) and one or more interfering devices (140),
s is the interference signal,
Hₗ is an estimation by the second node (122) of a fourth radio channel between the second node (122) and the one or more devices (130), and
Nₗ indicates receiver noise at the second node (122).

Example 20. The method according to example 19, wherein the pilots sequences are normalized such that all of them satisfy ∥φₖ∥²=1.

Example 21. The method according to any of examples 16-20, wherein the obtaining (601) of the first indication comprises applying a data compression algorithm.

Example 22. The method according to any of examples 16-21, wherein at least one of:
a) each of the nodes in the set of nodes (120) is an Access Point, AP,
b) each of the nodes in the set of nodes (120) has a respective plurality of antennas (M),
c) the communications network (100) is a distributed Multiple Input Multiple Output, d-MIMO, network,
d) the first network node (111) is a central processing unit, CPU, of the d-MIMO network,
e) the set of nodes (120) are arranged with a stripe topology, and
f) the set of nodes (120) are arranged with a stripe topology, wherein the first node (121) and the second node (122) are immediately adjacent.

### Further Extensions And Variations

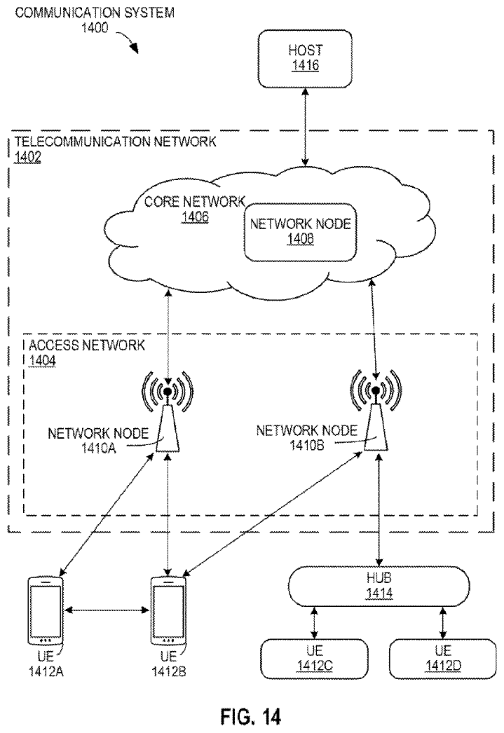

FIG. 14 shows an example of a communication system 1400 in accordance with some embodiments.

In the example, the communication system 1400, such as the wireless communications network 100, includes a telecommunication network 1402 that includes an access network 1404, such as a radio access network (RAN), and a core network 1406, which includes one or more core network nodes 1408. The access network 1404 includes one or more access network nodes, such as the first network node 111 and/or any of the set of nodes 120, such as the first node 121 and the second node 122. For example, network nodes 1410a and 1410b, one or more of which may be generally referred to as network nodes 1410, or any other similar 3^{rd} Generation Partnership Project (3GPP) access node or non-3GPP access point. The communications system 1400 comprises a plurality of wireless devices, such as the one or more devices 130. In FIG. 14, the plurality of wireless devices comprises UEs 1412a, 1412b, 1412c, and 1412d, one or more of which may be generally referred to as UEs 1412. The network nodes 1410 facilitate direct or indirect connection of user equipment (UE), such as by connecting UEs 1412a, 1412b, 1412c, and 1412d to the core network 1406 over one or more wireless connections. Any of the UEs 1412a, 1412b, 1412c, and 1412d are examples of the one or more devices 130.

In relation to FIGS. 14, 15, and 16, which are described next, it may be understood that any UE is an example of the one or more devices 130, and that any description provided for the UE 1412 or for the UE 1606 equally applies to the one or more devices 130. It may be also understood that any network node is an example of the first network node 111 and/or any of the set of nodes 120, such as the first node 121 and the second node 122, and that any description provided for any network node 1410 or for the network node 1604 equally applies to the first network node 111 and/or any of the set of nodes 120, such as the first node 121 and the second node 122. It may further be understood that the communication system 1400 is an example of the wireless communication network 100, and that any description provided for the communication system 1400 equally applies to the wireless communication network 100.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The one or more devices 130, exemplified in FIG. 14 as the UEs 1412, may be any of a wide variety of communication devices, including wireless devices arranged, configured, and/or operable to communicate wirelessly with the first network node 111 and/or any of the set of nodes 120, such as the first node 121 and the second node 122, exemplified in FIG. 14 as network nodes 1410, and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes, e.g., core network node 1408, that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, New Radio (NR) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1414 communicates with the access network 1404 to facilitate indirect communication between one or more UEs, e.g., UE 1412c and/or 1412d, and network nodes, e.g., network node 1410b. In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410b. The hub 1414 may also allow for a different communication scheme and/or schedule between the hub 1414 and UEs (e.g., UE 1412c and/or 1412d), and between the hub 1414 and the core network 1406. In other examples, the hub 1414 is connected to the core network 1406 and/or one or more UEs via a wired connection. Moreover, the hub 1414 may be configured to connect to an M2M service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410b. In other embodiments, the hub 1414 may be a non-dedicated hub—that is, a device which is capable of operating to route communications between the UEs and network node 1410b, but which is additionally capable of operating as a communication start and/or end point for certain data channels.

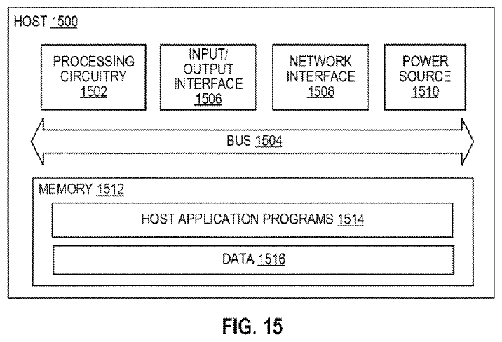

FIG. 15 is a block diagram of a host 1500, which may be an embodiment of the host 1416 of FIG. 14, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs, (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

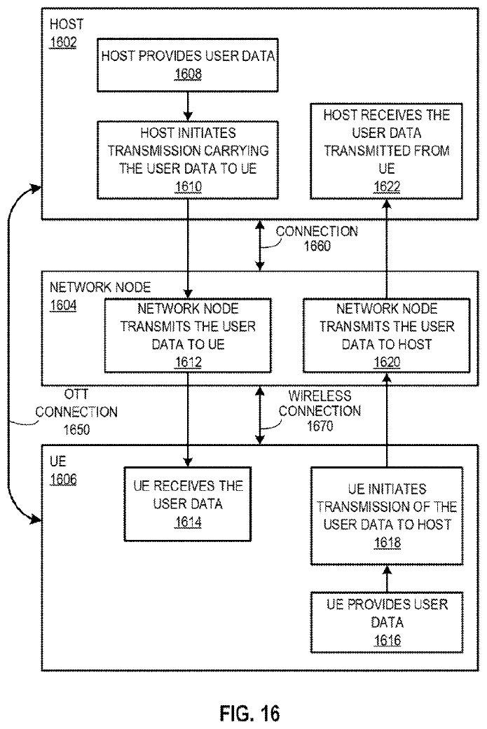

FIG. 16 shows a communication diagram of a host 1602 communicating via a network node 1604 with a UE 1606 over a partially wireless connection in accordance with some embodiments. Example implementations, in accordance with various embodiments, of the UE, such as a UE 1412a of Figure QQ, network node, such as network node 1410a of FIG. 14, and host, such as host 1416 of FIG. 14 and/or host 1500 of FIG. 15, discussed in the preceding paragraphs will now be described with reference to FIG. 16.

Like host 1500, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1406 of FIG. 14) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the userdata. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may improve the data rate, latency, power consumption and thereby provide benefits such as reduced user waiting time, relaxed restriction on file size, improved content resolution, better responsiveness, and extended battery lifetime.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion, e.g., controlling traffic lights. As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors, not shown, may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

The first node 121 embodiments relate to FIG. 4, FIGS. 7-11, FIG. 14 and FIG. 16.

The first node 121 may also be configured to communicate user data with a host application unit in a host 1416, 1500, 1602, e.g., via an OTT connection such as OTT connection 1650.

The first node 121 may comprise an interface unit to facilitate communications between the first node 121 and other nodes or devices, e.g., the first network node 111, the second node 122, the third node 123, the other nodes in the set of nodes 120, the one or more devices 130, the host 1416, 1500, 1602, or any of the other nodes. In some particular examples, the interface may, for example, include a transceiver configured to transmit and receive radio signals over an air interface in accordance with a suitable standard.

The first network node 111 embodiments relate to FIG. 5, FIGS. 7-10, FIG. 12, FIG. 14 and FIG. 16.

The first network node 111 may also be configured to communicate user data with a host application unit in a host 1416, 1500, 1602, e.g., via a connection 1660.

The first network node 111 may comprise an interface unit to facilitate communications between the first network node 111 and other nodes or devices, e.g., the first node 121, the second node 122, the nodes in the set of nodes 120, the one or more devices 130, the host 1416, 1500, 1602, or any of the other nodes. In some particular examples, the interface may, for example, include a transceiver configured to transmit and receive radio signals over an air interface in accordance with a suitable standard.

The second node 122 embodiments relate to FIG. 6, FIGS. 7-10, FIG. 13, FIG. 14 and FIG. 16.

The second node 122 may also be configured to communicate user data with a host application unit in a host 1416, 1500, 1602, e.g., via an OTT connection such as OTT connection 1650.

The second node 122 may comprise an interface unit to facilitate communications between the second node 122 and other nodes or devices, e.g., the first network node 111, the first node 121, the third node 123, the other nodes in the set of nodes 120, the one or more devices 130, the host 1416, 1500, 1602, or any of the other nodes. In some particular examples, the interface may, for example, include a transceiver configured to transmit and receive radio signals over an air interface in accordance with a suitable standard.

### Further Numbered Embodiments

1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform one or more of the actions described herein as performed by the first network node 111 and/or any of the set of nodes 120, such as the first node 121 and the second node 122.

2. The host of the previous embodiment, wherein:
the processing circuitry of the host is configured to execute a host application that provides the user data; and
the UE comprises processing circuitry configured to execute a client application associated with the host application to receive the transmission of user data from the host.

3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs one or more of the actions described herein as performed by the first network node 111 and/or any of the set of nodes 120, such as the first node 121 and the second node 122.

4. The method of the previous embodiment, further comprising, at the network node, transmitting the user data provided by the host for the UE.

5. The method of any of the previous 2 embodiments, wherein the user data is provided at the host by executing a host application that interacts with a client application executing on the UE, the client application being associated with the host application.

6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform one or more of the actions described herein as performed by the first network node 111 and/or any of the set of nodes 120, such as the first node 121 and the second node 122.

7. The communication system of the previous embodiment, further comprising: the network node; and/or the user equipment.

8. The communication system of the previous 2 embodiments, wherein:
the processing circuitry of the host is configured to execute a host application, thereby providing the user data; and
the host application is configured to interact with a client application executing on the UE, the client application being associated with the host application.

9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform one or more of the actions described herein as performed by the first network node 111 and/or any of the set of nodes 120, such as the first node 121 and the second node 122.

10. The host of the previous 2 embodiments, wherein:
the processing circuitry of the host is configured to execute a host application, thereby providing the user data; and
the host application is configured to interact with a client application executing on the UE, the client application being associated with the host application.

11. The host of the any of the previous 2 embodiments, wherein the initiating receipt of the user data comprises requesting the user data.

12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs one or more of the actions described herein as performed by the first network node 111 and/or any of the set of nodes 120, such as the first node 121 and the second node 122.

13. The method of the previous embodiment, further comprising at the network node, transmitting the received user data to the host.

14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform one or more of the actions described herein as performed by the one or more devices 130.

15. The host of the previous embodiment, wherein the cellular network further includes a network node configured to communicate with the UE to transmit the user data to the UE from the host.

16. The host of the previous 2 embodiments, wherein:
the processing circuitry of the host is configured to execute a host application, thereby providing the user data; and
the host application is configured to interact with a client application executing on the UE, the client application being associated with the host application.

17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs one or more of the actions described herein as performed by the one or more devices 130.

18. The method of the previous embodiment, further comprising:
at the host, executing a host application associated with a client application executing on the UE to receive the user data from the UE.

19. The method of the previous embodiment, further comprising:
at the host, transmitting input data to the client application executing on the UE, the input data being provided by executing the host application,
wherein the user data is provided by the client application in response to the input data from the host application.

20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform one or more of the actions described herein as performed by the one or more devices 130.

21. The host of the previous embodiment, wherein the cellular network further includes a network node configured to communicate with the UE to transmit the user data from the UE to the host.

22. The host of the previous 2 embodiments, wherein:
the processing circuitry of the host is configured to execute a host application, thereby providing the user data; and
the host application is configured to interact with a client application executing on the UE, the client application being associated with the host application.

23. A method implemented by a host configured to operate in a communication system that further includes a network node and a user equipment (UE), the method comprising:
at the host, receiving user data transmitted to the host via the network node by the UE, wherein the UE performs one or more of the actions described herein as performed by the one or more devices 130.

24. The method of the previous embodiment, further comprising:
at the host, executing a host application associated with a client application executing on the UE to receive the user data from the UE.

25. The method of the previous embodiments, further comprising:
at the host, transmitting input data to the client application executing on the UE, the input data being provided by executing the host application,
wherein the user data is provided by the client application in response to the input data from the host application.

### REFERENCE LIST

1. Z. H. Shaik, E. Björnsson, and E. G. Larsson, “Distributed Computation of A Posteriori Bit Likelihood Ratios in Cell-Free Massive MIMO,” In Proc. European Signal Processing Conference (EUSIPCO), 2021.
2. Optimal uplink D-MIMO processing using Kalman filtering, unpublished internal document on the day of filing of the priority application,
3. J. Karlsson and J. Heinegård, “Interference rejection combining for GSM,” in Proc. International Conference on Universal Personal Communications (ICUPC), 1996.

1. A method performed by a first node, the method being for handling an interference signal, the first node operating in a communications network, and the first node being comprised in a set of nodes providing a segmented front-haul, the method comprising:
obtaining at least a first indication
$$( {Z}_{l - 1} , {\sum }_{i = 1}^{l - 1} {Z}_{i}^{H} {Z}_{i} , {\text{?}}_{( l - 1 )} )$$
of an interference signal (s) from a second node operating in the communications network and comprised in the set of nodes, wherein the interference signal (s) originates from one or more interfering devices outside of the communications network,
obtaining a second indication
$$( {Z}_{l} , {\text{?}}_{l}^{o} )$$
of the interference signal (s) from uplink measurements performed by the first node,
determining a third indication
$$( {Z}_{l} , {Z}_{l}^{H} {Z}_{l} , {\sum }_{l = 1}^{L} {Z}_{l}^{H} {Z}_{l} , {\text{?}}_{l} )$$
of the interference signal (s) as a combination of the obtained first indication
$$( {Z}_{l - 1} , {\sum }_{i = 1}^{l - 1} {Z}_{i}^{H} {Z}_{i} , {\text{?}}_{( l - 1 )} )$$
and the obtained second indication
$$( {Z}_{l} , {\text{?}}_{l}^{o} ) ,$$
and
sending the third indication
$$( {Z}_{l} , {Z}_{l}^{H} {Z}_{l} , {\sum }_{l = 1}^{L} {Z}_{l}^{H} {Z}_{l} , {\text{?}}_{l} )$$
a third node operating in the communications network and comprised in the set of nodes or to a first network node operating in the communications network and having a connection to the set of nodes.

2. The method according to claim 1, further comprising at least one of:
obtaining, directly or indirectly, from the first network node, a fourth indication ( [symbol] ₗ) of the interference signal, the fourth indication ( [symbol] ₗ) being based on an estimation of the interference signal by the first network node based on at least the third indication
$$( {Z}_{l} , {Z}_{l}^{H} {Z}_{l} , {\sum }_{l = 1}^{L} {Z}_{l}^{H} {Z}_{l} , {\text{?}}_{l} )$$
sent by the first node,
estimating a first radio channel (ĝₗ) between the first node and the one or more interfering devices, and
detecting one or more uplink signals from one or more devices operating in the communications network, using the estimated first radio channel (ĝₗ) and the fourth indication of the interference signal ( [symbol] ₗ) to perform suppression of interference.

3. The method according to claim 1, wherein the obtaining of the second indication is performed by subtracting from the uplink measurements performed by the first node an estimate of a received signal in the uplink measurements corresponding to only contributions from transmissions of known pilot sequences and noise.

4. The method according to claim 3, wherein the pilot sequences (φₖ) are normalized such that all of them satisfy ∥φₖ∥²=1.

5. The method according to claim 1, wherein the determining of the third indication ( [symbol] ₗ) of the interference signal (s) is performed by sequential averaging and phase rotation according to the following formula:
$${\text{?}}_{l} = 0.5 ( {\text{?}}_{( l - 1 )} + {\text{?}}_{l}^{o} {e}^{j {α}_{l}} )$$
wherein the phase rotation is calculated based on the following formula:
$${α}_{l} = - arg ( {\text{?}}_{( l - 1 )}^{H} {\text{?}}_{l}^{o} ) ,$$
in order to “align”
$${\text{?}}_{( l - 1 )} with {\text{?}}_{l}^{o} .$$
$$where :$$
$$- {\text{?}}_{l}^{o}$$
is a right singular vector of ZₗΨ computed at any of nodes in the set of nodes
Ψ is a decomposition of matrix P=I−ΦΦ^{H}, such that P=ΨΨ^{H}, where T is a tall matrix that satisfies Ψ^{H}Ψ=I,
P=I−ΦΦ^{H} is an orthogonal projection matrix of a pilot matrix Φ,
e^{jα}^{ₗ} denotes Euler's number e to the power of jαₗ, and
j denotes an imaginary unit (\sqrt{−1}).

6. The method according to claim 1, wherein the obtaining of the second indication comprises applying a data compression algorithm.

7-8. (canceled)

9. A method performed by a first network node, the method being for handling an interference signal (s), the first network node operating in a communications network comprising a set of nodes providing a segmented front-haul, the method comprising:
obtaining a third indication
$$( {Z}_{l} , {Z}_{l}^{H} {Z}_{l} , {\sum }_{l = 1}^{L} {Z}_{l}^{H} {Z}_{l} , {\text{?}}_{l} )$$
from a first node comprised in the set of nodes, the third indication being of an interference signal (s), wherein the interference signal (s) originates from one or more interfering devices outside of the communications network, and wherein the third indication is of the interference signal (s) as a combination of at least a first indication
$$( {Z}_{l - 1} , {\sum }_{i = 1}^{l - 1} {Z}_{i}^{H} {Z}_{i} , {\text{?}}_{( l - 1 )} )$$
of the interference signal (s) from a second node operating in the communications network and comprised in the set of nodes, and a second indication
$$( {Z}_{l} , {\text{?}}_{l}^{o} )$$
of the interference signal (s), as obtained by the first node from uplink measurements performed by the first node,
determining a fourth indication ( [symbol] ₗ) of the interference signal, the fourth indication ( [symbol] ₗ) being based on an estimation of the interference signal by the first network node based on at least the third indication
$$( {Z}_{l} , {Z}_{l}^{H} {Z}_{l} , {\sum }_{l = 1}^{L} {Z}_{l}^{H} {Z}_{l} , {\text{?}}_{l} )$$
obtained from the first node, and
sending, directly or indirectly, the fourth indication to the first node.

10. (canceled)

11. The method according to claim 6, wherein the determining of the fourth indication ( [symbol] ₗ) is performed by solving a least squares problem according to the following formula:
$${minimize}_{g , \overline{s}} {‖ Z Ψ - g {\overline{s}}^{H} ‖}_{F}$$
where:
g is a first radio channel between the set of nodes and one or more interfering devices,
s̅ is an estimate the interference signal,
ZₗΨ is a dominant right singular vector,
s̅^{H} is an estimate the interference signal in the second radio channel between the set of nodes and one or more devices operating in the communications network,
$$Z = {[ \begin{matrix}{Z}_{1}^{T} & … & {Z}_{L}^{T}\end{matrix} ]}^{T} ,$$
and
$$g = {[ \begin{matrix}{g}_{1}^{T} & … & {g}_{L}^{T}\end{matrix} ]}^{T} ,$$
T is a transpose operator,
F is the Frobenius norm,
Ψ is a decomposition of matrix P=I−ΦΦ^{H}, such that P=ΨΨ^{H}, where Ψ is a tall matrix that satisfies Ψ^{H}Ψ=I,
P=I−ΦΦ^{H} is an orthogonal projection matrix of a pilot matrix Φ, and and the solution is given by the best rank-1 approximation of ZΨ, and the estimate of s is given by the dominant eigenvector of Ψ^{H}Z^{H}Ψ.

12. The method according to claim 6, wherein the second indication is obtained by subtracting from the uplink measurements performed by the first node an estimate of a received signal in the uplink measurements corresponding to only contributions from transmissions of known pilot sequences and noise.

13. The method according to claim 9, wherein the pilot sequences (Φₖ) are normalized such that all of them satisfy ∥φₖ∥²=1.

14. The method according to claim 9, wherein the third indication ( [symbol] ₗ) of the interference signal (s) is determined by sequential averaging and phase rotation according to the following formula:
$${\text{?}}_{l} = 0.5 ( {\text{?}}_{( l - 1 )} + {\text{?}}_{l}^{o} {e}^{j {α}_{l}} )$$
wherein the phase rotation is calculated based on the following formula:
$${α}_{l} = - arg ( {\text{?}}_{( l - 1 )}^{H} {\text{?}}_{l}^{o} ) ,$$
in order to “align”
$${\text{?}}_{( l - 1 )} with {\text{?}}_{l}^{o} .$$
$$where :$$
$$- {\text{?}}_{l}^{o}$$
is a right singular vector of ZₗΨ computed at any of nodes in the set of nodes (120),
Ψ is a decomposition of matrix P=I−ΦΦ^{H}, such that P=ΨΨ^{H}, where Ψ is a tall matrix that satisfies Ψ^{H}Ψ=I,
P=I−ΦΦ^{H} is an orthogonal projection matrix of a pilot matrix Φ,
e^{jα}^{ₗ} denotes Euler's number e to the power of jαₗ, and
j denotes an imaginary unit (VET).

15-25. (canceled)

26. A first node, for handling an interference signal (s), the first node being configured to operate in a communications network, and the first node being configured to be comprised in a set of nodes configured to provide a segmented front-haul, the first node being further configured to:
obtain at least a first indication
$$( {Z}_{l - 1} , {\sum }_{i = 1}^{l - 1} {Z}_{i}^{H} {Z}_{i} , {\text{?}}_{( l - 1 )} )$$
of an interference signal (s) from a second node configured to operate in the communications network and configured to be comprised in the set of nodes, wherein the interference signal (s) is configured to originate from one or more interfering devices outside of the communications network,
obtain a second indication
$$( {Z}_{l} , {\text{?}}_{l}^{o} )$$
of the interference signal (s) from uplink measurements configured to be performed by the first node,
determine a third indication
$$( {Z}_{l} , {Z}_{l}^{H} {Z}_{l} , {\sum }_{l = 1}^{L} {Z}_{l}^{H} {Z}_{l} , {\text{?}}_{l} )$$
of the interference signal (s) as a combination of the obtained first indication
$$( {Z}_{l - 1} , {\sum }_{i = 1}^{l - 1} {Z}_{i}^{H} {Z}_{i} , {\text{?}}_{( l - 1 )} )$$
and the obtained second indication
$$( {Z}_{l} , {\text{?}}_{l}^{o} ) ,$$
and
send the third indication
$$( {Z}_{l} , {Z}_{l}^{H} {Z}_{l} , {\sum }_{l = 1}^{L} {Z}_{l}^{H} {Z}_{l} , {\text{?}}_{l} )$$
to a third node configured to operate in the communications network and configured to be comprised in the set of nodes or to a first network node configured to operate in the communications network and configured to have a connection to the set of nodes.

27. The first node according to claim 26, being further configured to at least one of:
obtain, directly or indirectly, from the first network node, a fourth indication ( [symbol] ₗ) of the interference signal, the fourth indication ( [symbol] ₗ) being configured to be based on an estimation of the interference signal by the first network node based on at least the third indication
$$( {Z}_{l} , {Z}_{l}^{H} {Z}_{l} , {\sum }_{l = 1}^{L} {Z}_{l}^{H} {Z}_{l} , {\text{?}}_{l} )$$
configured to be sent by the first node,
estimate a first radio channel (ĝₗ) between the first node and the one or more interfering devices, and
detect one or more uplink signals from one or more devices configured to operate in the communications network, using the estimated first radio channel (ĝₗ) and the fourth indication of the interference signal (s̅ₗ) to perform suppression of interference.

28. The first node according to claim 26, wherein the obtaining of the second indication is configured to be performed by subtracting from the uplink measurements configured to be performed by the first node an estimate of a received signal in the uplink measurements corresponding to only contributions from transmissions of known pilot sequences and noise.

29. The first node according to claim 28, wherein the pilot sequences (Φₖ) are configured to be normalized such that all of them satisfy ∥φₖ∥²=1.

30. The first node according to claim 26, wherein the determining of the third indication ( [symbol] ₗ) of the interference signal (s) is configured to be performed by sequential averaging and phase rotation according to the following formula:
$${\text{?}}_{l} = 0.5 ( {\text{?}}_{( l - 1 )} + {\text{?}}_{l}^{o} {e}^{j {α}_{l}} )$$
wherein the phase rotation is configured to be calculated based on the following formula:
$${α}_{l} = - arg ( {\text{?}}_{( l - 1 )}^{H} {\text{?}}_{l}^{o} ) ,$$
in order to “align”
$${\text{?}}_{( l - 1 )} with {\text{?}}_{l}^{o} .$$
$$where :$$
$${\text{?}}_{l}^{o}$$
is configured to be a right singular vector of ZₗΨ configured to be computed at any of nodes in the set of nodes,
Ψ is configured to be a decomposition of matrix P=I−ΦΦ^{H}, such that P=ΨΨ^{H} where Ψ is a tall matrix that satisfies Ψ^{H}Ψ=I,
P=I−ΦΦ^{H} is configured to be an orthogonal projection matrix of a pilot matrix Φ,
e^{jα}^{ₗ} is configured to denote Euler's number e to the power of jαₗ, and
j is configured to denote an imaginary unit (\sqrt{−1}).

31. The first node according to claim 26, wherein the obtaining of the second indication is configured to comprise applying a data compression algorithm.

32. The first node according to claim 31, wherein the data compression algorithm is configured to comprise a singular value decomposition in which only a leading singular vector component is configured to be kept.

33. The first node according to claim 26, wherein at least one of:
a) each of the nodes in the set of nodes is configured to be an Access Point, AP,
b) each of the nodes in the set of nodes is configured to have a respective plurality of antennas (M),
c) the communications network is configured to be a distributed Multiple Input Multiple Output, d-MIMO, network,
d) the first network node is configured to be a central processing unit, CPU, of the d-MIMO network,
e) the set of nodes are configured to be arranged with a stripe topology,
f) the set of nodes are configured to be arranged with a radioweave topology, and
g) the set of nodes are configured to be arranged with a stripe topology, wherein the first node and the second node are configured to be immediately adjacent.

34-51. (canceled)
